(19) United States
(12) Patent Application Publication
(10) Pub. No.: US 2025/0110419 A1
(43) Pub. Date: Apr. 3, 2025

(54) LIGHT SCANNING APPARATUS AND IMAGE FORMING APPARATUS

(71) Applicant: CANON KABUSHIKI KAISHA, Tokyo (JP)

(72) Inventors: Ryota SATO, Tochigi (JP); Masayasu TERAMURA, Tochigi (JP)

(21) Appl. No.: 18/888,212

(22) Filed: Sep. 18, 2024

(30) Foreign Application Priority Data
Sep. 28, 2023 (JP) 2023-166649

(51) Int. Cl. G03G 15/043; B41J 2/47; G02B 26/12; G03G 15/04

(52) U.S. Cl. CPC G03G 15/0435; B41J 2/471; G02B 26/125; G03G 15/04036

(57) ABSTRACT

Provided is a light scanning apparatus including a deflecting unit configured to deflect a first light flux from a first light source to scan a first scanned surface in a main scanning direction, a first imaging optical system and a reflecting element which are configured to guide the first light flux deflected by the deflecting unit to the first scanned surface, an optical element configured to guide the first light flux emitted from the first light source to the deflecting unit, and a holding member configured to hold the deflecting unit, the first imaging optical system, the reflecting element, and the optical element, in which the optical element and the reflecting element abut against the holding member.

### BACKGROUND

### Technical Field

The present disclosure relates to a light scanning apparatus, and more particularly, to a light scanning apparatus suitable for use in an image forming apparatus, for example, a laser beam printer, a digital copying machine, or a multifunction printer.

### Description of the Related Art

A light scanning apparatus including a plurality of holding units each holding one of a plurality of optical elements has hitherto been known.

In Japanese Patent Application Laid-Open No. 2016-133777, there is disclosed a light scanning apparatus in which a reflecting mirror for bending an optical path of a light flux deflected by a deflecting unit is held by a holding unit formed so as to be integrated with a housing.

A collimator lens for converting a light flux emitted from a light source into a parallel light flux, on the other hand, is held by a light source unit for holding the light source. The light source unit is fastened to the housing by fastening screws.

### SUMMARY

According to the embodiments, there is provided a light scanning apparatus including, a deflecting unit configured to deflect a first light flux from a first light source to scan a first scanned surface in a main scanning direction, a first imaging optical system and a reflecting element which are configured to guide the first light flux deflected by the deflecting unit to the first scanned surface, an optical element configured to guide the first light flux emitted from the first light source to the deflecting unit, and a holding member configured to hold the deflecting unit, the first imaging optical system, the reflecting element, and the optical element, in which the optical element and the reflecting element abut against the holding member.

Further features of the present disclosure will become apparent from the following description of exemplary embodiments with reference to the attached drawings.

### BRIEF DESCRIPTION OF THE DRAWINGS

FIG. 1A is a developed view in a main scanning cross section of a light scanning apparatus according to a first embodiment of the present invention.

FIG. 1B is a partial sub-scanning cross sectional view of the light scanning apparatus according to the first embodiment.

FIG. 2 is a sub-scanning cross sectional view of a first imaging optical element included in the light scanning apparatus according to the first embodiment.

FIG. 3 is a partial projected view in a main scanning cross section of the light scanning apparatus according to the first embodiment.

FIG. 4A is a frontal view of a first incident optical element included in the light scanning apparatus according to the first embodiment.

FIG. 4B is a side-elevational view of the first incident optical element included in the light scanning apparatus according to the first embodiment.

FIG. 5A is a view of the light scanning apparatus according to the first embodiment as viewed from an optical axis direction in the vicinity of the first incident optical element.

FIG. 5B is a view of the light scanning apparatus according to the first embodiment as viewed from a main scanning direction in the vicinity of the first incident optical element.

FIG. 5C is a view of the light scanning apparatus according to the first embodiment as viewed from a sub-scanning direction in the vicinity of the first incident optical element.

FIG. 6A is a graph for showing image height dependence of an LSF depth center position in the main scanning direction on each scanned surface in the light scanning apparatus according to the first embodiment.

FIG. 6B is a graph for showing image height dependence of an LSF depth center position in the sub-scanning direction on each scanned surface in the light scanning apparatus according to the first embodiment.

FIG. 7 is a partial projected view in the main scanning cross section of the light scanning apparatus according to the first embodiment.

FIG. 8A is a developed view in the main scanning cross section of a light scanning apparatus according to a second embodiment of the present invention.

FIG. 8B is a partial sub-scanning cross sectional view of the light scanning apparatus according to the second embodiment.

FIG. 9 is a partial projected view in the main scanning cross section of the light scanning apparatus according to the second embodiment.

FIG. 10A is a graph for showing image height dependence of the LSF depth center position in the main scanning direction on each scanned surface in the light scanning apparatus according to the second embodiment.

FIG. 10B is a graph for showing image height dependence of the LSF depth center position in the sub-scanning direction on each scanned surface in the light scanning apparatus according to the second embodiment.

FIG. 11A is a developed view in the main scanning cross section of a light scanning apparatus according to a third embodiment of the present invention.

FIG. 11B is a partial sub-scanning cross sectional view of the light scanning apparatus according to the third embodiment.

FIG. 12 is a partial projected view in the main scanning cross section of the light scanning apparatus according to the third embodiment.

FIG. 13A is a graph for showing image height dependence of the LSF depth center position in the main scanning direction on each scanned surface in the light scanning apparatus according to the third embodiment.

FIG. 13B is a graph for showing image height dependence of the LSF depth center position in the sub-scanning direction on each scanned surface in the light scanning apparatus according to the third embodiment.

FIG. 14 is a sub-scanning cross sectional view of a main part of an image forming apparatus according to the present embodiments.

### DESCRIPTION OF THE EMBODIMENTS

A light scanning apparatus according to the present embodiments is described in detail below with reference to the accompanying drawings. Some of the drawings referred to below may be drawn in scales different from the actual scale for easier understanding of the present disclosure.

In the following description, a main scanning direction refers to a direction perpendicular to a rotational axis of a deflecting unit 50 and to optical axes of first to fourth imaging optical systems (a direction in which a light flux is deflected by the deflecting unit 50).

A sub-scanning direction refers to a direction parallel to the rotational axis of the deflecting unit 50. A main scanning cross section refers to a cross section perpendicular to the sub-scanning direction. A sub-scanning cross section refers to a cross section perpendicular to the main scanning direction.

In the following, an optical axis direction of the first to fourth imaging optical systems, the main scanning direction, and the sub-scanning direction are defined as an X-direction, a Y-direction, and a Z-direction, respectively.

The X-direction may also be defined as a direction (first direction) parallel to a straight line running through a first intersection between a first scanned surface 100a and the optical axis of the first imaging optical system, and through a second intersection between a second scanned surface 100b and the optical axis of the second imaging optical system.

### First Embodiment

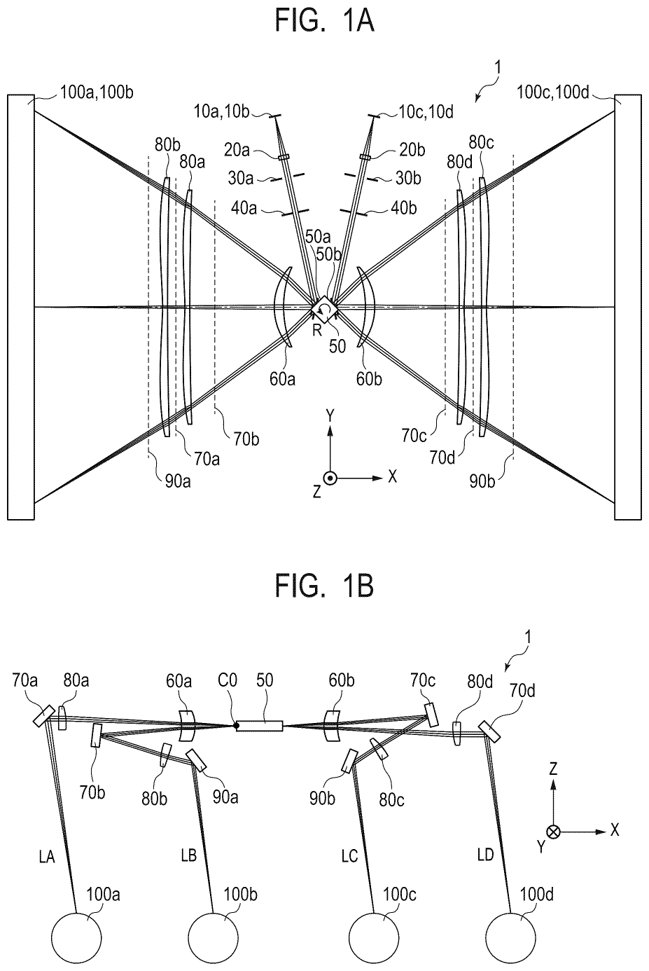

FIG. 1A and FIG. 1B show a developed view in a main scanning cross section and a partial sub-scanning cross sectional view, respectively, of a light scanning apparatus 1 according to a first embodiment of the present invention.

In FIG. 1A, first reflecting elements (reflecting optical elements) 70a, 70b, 70c, and 70d and second reflecting elements (reflecting optical elements) 90a and 90b are indicated by broken lines.

The light scanning apparatus 1 according to the present embodiment includes a housing 2 (a holding member) and first, second, third, and fourth light sources 10a, 10b, 10c, and 10d, as well as first and second incident optical elements 20a and 20b (refractive optical elements).

The light scanning apparatus 1 according to the present embodiment also includes first and second sub-scanning stops 30a and 30b, first and second main scanning stops 40a and 40b, and the deflecting unit 50.

The light scanning apparatus 1 according to the present embodiment also includes first imaging optical elements 60a and 60b, the first reflecting elements 70a to 70d, second imaging optical elements 80a, 80b, 80c, and 80d, and the second reflecting elements 90a and 90b.

The housing 2 is configured so as to hold and simultaneously house the optical elements provided in the light scanning apparatus 1 according to the present embodiment.

The first to fourth light sources 10a to 10d are each a light source, such as a semiconductor laser, with two light emitting points. That is, the light scanning apparatus 1 according to the present embodiment is provided with eight light emitting points in total.

The first light source 10a and the second light source 10b are placed in the same position in the main scanning cross section, whereas being placed in positions different from each other in the sub-scanning direction.

The third light source 10c and the fourth light source 10d are placed in the same position in the main scanning cross section, whereas being placed in positions different from each other in the sub-scanning direction.

The first and second incident optical elements 20a and 20b are formed from anamorphic lenses having magnitudes of refractive power that differ in the main scanning cross section and a sub-scanning cross section.

The first incident optical element 20a converts degrees of convergence of first and second light fluxes LA and LB emitted from the first and second light sources 10a and 10b, respectively, so that the first and second light fluxes LA and LB become parallel light fluxes in the main scanning direction.

Similarly, the second incident optical element 20b converts degrees of convergence of third and fourth light fluxes LC and LD emitted from the third and fourth light sources 10c and 10d, respectively, so that the third and fourth light fluxes LC and LD become parallel light fluxes in the main scanning direction.

It is assumed that the parallel light flux here includes not only a strict parallel light flux but also substantially parallel light fluxes including a weak divergent light flux and a weak convergent light flux.

The first incident optical element 20a condenses the first and second light fluxes LA and LB emitted from the first and second light sources 10a and 10b, respectively, toward the deflecting unit 50 in the sub-scanning direction.

Similarly, the second incident optical element 20b condenses the third and fourth light fluxes LC and LD emitted from the third and fourth light sources 10c and 10d, respectively, toward the deflecting unit 50 in the sub-scanning direction.

Detailed configurations of the first incident optical element 20a and the second incident optical element 20b are described later.

The first sub-scanning stop 30a includes a lower aperture portion 30al (first aperture portion) and an upper aperture portion 30au (second aperture portion) which have a quadrangular shape to regulate, in the sub-scanning direction, light flux widths of the first and second light fluxes LA and LB having traveled through the first incident optical element 20a.

Similarly, the second sub-scanning stop 30b includes two aperture portions which have a quadrangular shape to regulate, in the sub-scanning direction, light flux widths of the third and fourth light fluxes LC and LD having traveled through the second incident optical element 20b.

The first main scanning stop 40a includes a single aperture portion which has a quadrangular shape to regulate, in the main scanning direction, light flux widths of the first and second light fluxes LA and LB having traveled through the first sub-scanning stop 30a.

Similarly, the second main scanning stop 40b includes a single aperture portion which has a quadrangular shape to regulate, in the main scanning direction, light flux widths of the third and fourth light fluxes LC and LD having traveled through the second sub-scanning stop 30b.

The deflecting unit 50 is a polygon mirror (rotary polygon mirror) having four deflecting surfaces, and is driven by a driving unit (not shown) such as a motor to rotate at a constant speed in a direction of an arrow R indicated in FIG. 1A.

The first imaging optical elements 60a and 60b and the second imaging optical elements 80a to 80d are fθ lenses (scanning lenses) having fθ characteristics.

The first imaging optical element 60a and the second imaging optical element 80a condense (guide) the first light flux LA deflected by the deflecting unit 50, to a scanning region (an image forming region) of the first scanned surface 100a, to thereby form a spot image on the scanning region.

The first imaging optical element 60a and the second imaging optical element 80b condense (guide) the second light flux LB deflected by the deflecting unit 50, to a scanning region of the second scanned surface 100b, to thereby form a spot image on the scanning region.

The first imaging optical element 60b and the second imaging optical element 80c condense (guide) the third light flux LC deflected by the deflecting unit 50, to a scanning region of a third scanned surface 100c, to thereby form a spot image on the scanning region.

The first imaging optical element 60b and the second imaging optical element 80d condense (guide) the fourth light flux LD deflected by the deflecting unit 50, to a scanning region of a fourth scanned surface 100d, to thereby form a spot image on the scanning region.

The first reflecting elements 70a to 70d and the second reflecting elements 90a and 90b are long mirrors with no refractive power which bend, in the sub-scanning cross section, optical paths of the first to fourth light fluxes LA to LD deflected by the deflecting unit 50.

The first and second incident optical elements 20a and 20b provided in the light scanning apparatus 1 according to the present embodiment are molded lenses formed by injection molding of a plastic material (resin material).

Similarly, the first imaging optical elements 60a and 60b and the second imaging optical elements 80a to 80d are molded lenses formed by injection molding of a plastic material (resin material).

However, those elements are not limited thereto, and may be molded lenses that are formed by injection molding of a glass material.

In the light scanning apparatus 1 according to the present embodiment, the use of molded lenses which are easy to form an optical surface having an aspherical shape and which are suitable for mass production can improve productivity and optical performance.

The first reflecting elements 70a to 70d and the second reflecting elements 90a and 90b provided in the light scanning apparatus 1 according to the present embodiment are long mirrors created by forming films as reflecting surfaces on general long pieces of glass, but are not limited thereto.

That is, the first and second reflecting elements may be long mirrors that are created by forming films as reflecting surfaces on members formed through injection molding of a plastic material, or long mirrors that are created by performing mirror-like finishing on metal members such as aluminum members.

In the light scanning apparatus 1 according to the present embodiment, the reflecting surfaces possessed by those are formed so as to have a flat shape with no refractive power, but are not limited thereto and may be formed so as to have spherical or other curved surface shapes.

The first and second light fluxes LA and LB emitted from the first and second light sources 10a and 10b, respectively, are converted into parallel light fluxes in the main scanning cross section, and are also condensed in the sub-scanning cross section, by the first incident optical element 20a.

After having traveled through the first incident optical element 20a, the first and second light fluxes LA and LB travel through the first sub-scanning stop 30a and the first main scanning stop 40a, and are then guided to a first deflecting surface 50a of the deflecting unit 50.

The first and second light fluxes LA and LB are thus regulated in light flux width in the main scanning direction and the sub-scanning direction, and are condensed in the sub-scanning direction so that a long line image is formed in the main scanning direction in the vicinity of the first deflecting surface 50a of the deflecting unit 50.

The third and fourth light fluxes LC and LD emitted from the third and fourth light sources 10c and 10d, respectively, are converted into parallel light fluxes in the main scanning cross section, and are also condensed in the sub-scanning cross section, by the second incident optical element 20b.

After having traveled through the second incident optical element 20b, the third and fourth light fluxes LC and LD travel through the second sub-scanning stop 30b and the second main scanning stop 40b, and are then guided to a second deflecting surface 50b of the deflecting unit 50.

The third and fourth light fluxes LC and LD are thus regulated in light flux width in the main scanning direction and the sub-scanning direction, and are condensed in the sub-scanning direction so that a long line image is formed in the main scanning direction in the vicinity of the second deflecting surface 50b of the deflecting unit 50.

In the light scanning apparatus 1 according to the present embodiment, the first and second light fluxes LA and LB emitted from the first and second light sources 10a and 10b, respectively, are obliquely incident on the first deflecting surface 50a of the deflecting unit 50 at angles different from each other with respect to the main scanning cross section in the sub-scanning cross section.

Specifically, the first and second light fluxes LA and LB are obliquely incident on the first deflecting surface 50a of the deflecting unit 50 at angles of −2.70° and +2.70°, respectively, with respect to the main scanning cross section.

The third and fourth light fluxes LC and LD emitted from the third and fourth light sources 10c and 10d, respectively, are obliquely incident on the second deflecting surface 50b of the deflecting unit 50 at angles different from each other with respect to the main scanning cross section in the sub-scanning cross section.

Specifically, the third and fourth light fluxes LC and LD are obliquely incident on the second deflecting surface 50b of the deflecting unit 50 at angles of −2.70° and +2.70°, respectively, with respect to the main scanning cross section.

Next, the first and second light fluxes LA and LB deflected by the first deflecting surface 50a of the deflecting unit 50 are condensed onto the first and second scanned surfaces 100a and 100b, respectively, by the first imaging optical element 60a and by the second imaging optical elements 80a and 80b, respectively.

The third and fourth light fluxes LC and LD deflected by the second deflecting surface 50b of the deflecting unit 50 are condensed onto the third and fourth scanned surfaces 100c and 100d, respectively, by the first imaging optical element 60b and by the second imaging optical elements 80c and 80d, respectively.

Rotation of the deflecting unit 50 causes the first to fourth scanned surfaces 100a to 100d to be optically scanned with the first to fourth light fluxes LA to LD, respectively, in the main scanning direction at a uniform speed, to thereby allow images to be recorded on the first to fourth scanned surfaces 100a to 100d.

In the light scanning apparatus 1 according to the present embodiment, a synchronization detection optical system (not shown) is provided in order to determine writing start timing at which optical scanning on the first to fourth scanned surfaces 100a to 100d is to be started.

Specifically, a predetermined light flux deflected by the deflecting unit 50 to a predetermined direction is guided by a lens for synchronization detection (not shown) to a sensor for synchronization detection (not shown).

A synchronization detection signal (beam detection (BD) signal) acquired by detection of a signal output from the sensor for synchronization detection is used to determine light emission timing of each of the first to fourth light sources 10a to 10d.

In the light scanning apparatus 1 according to the present embodiment, a first incident optical system is formed from a lower portion 21al (first refractive optical portion) of the first incident optical element 20a in the sub-scanning direction, the lower aperture portion 30al of the first sub-scanning stop 30a, and the aperture portion of the first main scanning stop 40a.

A second incident optical system is formed from an upper portion 21au (second refractive optical portion) of the first incident optical element 20a in the sub-scanning direction, the upper aperture portion 30au of the first sub-scanning stop 30a, and the aperture portion of the first main scanning stop 40a.

A third incident optical system is formed from a lower portion of the second incident optical element 20b in the sub-scanning direction, the lower aperture portion of the second sub-scanning stop 30b, and the aperture portion of the second main scanning stop 40b.

A fourth incident optical system is formed from an upper portion of the second incident optical element 20b in the sub-scanning direction, the upper aperture portion of the second sub-scanning stop 30b, and the aperture portion of the second main scanning stop 40b.

In the light scanning apparatus 1 according to the present embodiment, the first imaging optical system is formed from an upper portion of the first imaging optical element 60a in the sub-scanning direction and the second imaging optical element 80a.

The second imaging optical system is formed from a lower portion of the first imaging optical element 60a in the sub-scanning direction and the second imaging optical element 80b.

The third imaging optical system is formed from an upper portion of the first imaging optical element 60b in the sub-scanning direction and the second imaging optical element 80c.

The fourth imaging optical system is formed from a lower portion of the first imaging optical element 60b in the sub-scanning direction and the second imaging optical element 80d.

Next, specification values of the light scanning apparatus 1 according to the present embodiment, refractive indices and coordinates of the respective optical elements, and shapes of optical surfaces of the respective optical elements are shown in Table 1, Table 2, and Table 3-1 and Table 3-2, respectively.

In Table 2, Table 3-1, and Table 3-2, information about only the first and second incident optical systems and the first and second imaging optical systems is shown.

That is, in Table 2, Table 3-1, and Table 3-2, information about the third and fourth incident optical systems and the third and fourth imaging optical systems is omitted.

TABLE 1

| | Parameter · | |
|---|---|---|
| Item | Unit | Value |
| Wavelength used by first to fourth light | λ [nm] | 790 |
| sources 10a to 10d | | |
| Scanning width of first to fourth scanned | h [nm] | 326 |
| surfaces 100a to 100d | | |
| Number of deflecting surfaces of | [Surface] | 4 |
| deflecting unit 50 | | |
| Circumscribed circle diameter of | Pd [mm] | 20 |
| deflecting unit 50 | | |
| Maximum scanning angle of deflecting | θmax | 0.787 |
| unit 50 | [rad] | |
| Rotation center coordinates of | (X, Y) | (6.03, −3.79) |
| deflecting unit 50 | [mm] | |
| Absolute value of incident angle of | θim [deg] | 78.00 |
| first to fourth incident optical systems | | |
| in main scanning cross section | | |
| Absolute value of incident angle of | θis [deg] | 2.70 |
| first to fourth incident optical systems | | |
| in sub-scanning cross section | | |
| Width of respective aperture portions of | As [mm] | 2.84 |
| first and second sub-scanning stops | | |
| 30a and 30b in sub-scanning direction | | |
| Width of respective aperture portions of | Am [mm] | 3.75 |
| first and second main scanning stops | | |
| 40a and 40b in main scanning direction | | |
| Distance in X-direction between on-axis | Lx [mm] | 25.98 |
| deflection point C0 and centers of exit | | |
| surfaces of first and second incident | | |
| optical elements 20a and 20b | | |
| Distance in Y-direction between on-axis | Ly [mm] | 122.24 |
| deflection point C0 and centers of exit | | |
| surfaces of first and second incident | | |
| optical elements 20a and 20b | | |
| Distance in XY cross section between | Lt [mm] | 125.11 |
| onn-axis deflection point C0 and | | |
| centers of exit surfaces of first and | | |
| second incident optical elements 20a | | |
| and 20b | | |
| Distance in optical axis direction of | Li [mm] | 161.70 |
| first to fourth incident optical systems | | |
| between first to fourth light sources | | |
| 10a to 10d and on-axis deflection point | | |
| C0 | | |
| Distance in X-direction between on-axis | Mx [mm] | 27.55 |
| deflection point C0 and centers of | | |
| reflecting surfaces of second reflecting | | |
| elements 90a and 90b | | |
| Distance in Y-direction between on-axis | My [mm] | 116.50 |
| deflection point C0 and centers of | | |
| reflecting surfaces of second reflecting | | |
| elements 90a and 90b | | |

TABLE 2

| | | | Refractive | | | | | | |
|---|---|---|---|---|---|---|---|---|---|
| | | Surface | index | | | | | | |
| Surface | | interval | (λ = 790 | Coordinates of surface vertex | | | Direction cosine of optical axis | | |
| number | | [mm] | nm) | tc(x) | tc(y) | tc(z) | gx(x) | gx(y) | gx(z) |
| 1 | First light | 0.250 | 1.000 | −33.582 | 157.991 | −7.617 | −0.208 | 0.977 | −0.047 |
| | source 10a | | | | | | | | |
| 2 | Glass cover | 33.340 | 1.511 | −33.530 | 157.747 | −7.605 | −0.208 | 0.977 | −0.047 |
| | for laser chip | | | | | | | | |
| 3 | Incident | 3.000 | 1.528 | −26.606 | 125.171 | −6.035 | −0.208 | 0.977 | −0.047 |
| | surface of | | | | | | | | |
| | lower portion | | | | | | | | |
| | 21al of first | | | | | | | | |
| | incident | | | | | | | | |
| | optical | | | | | | | | |
| | element 20a | | | | | | | | |
| 4 | Exit surface | 15.150 | 1.000 | −25.983 | 122.240 | −5.893 | −0.208 | 0.977 | −0.047 |
| | of lower | | | | | | | | |
| | portion 21al | | | | | | | | |
| | of first | | | | | | | | |
| | incident | | | | | | | | |
| | optical | | | | | | | | |
| | element 20a | | | | | | | | |
| 5 | Lower | 29.870 | 1.000 | −22.837 | 107.438 | −5.180 | −0.208 | 0.978 | 0.000 |
| | aperture | | | | | | | | |
| | portion 30al | | | | | | | | |
| | of first sub- | | | | | | | | |
| | scanning stop | | | | | | | | |
| | 30a | | | | | | | | |
| 6 | Aperture | 80.090 | 1.000 | −16.633 | 78.253 | −3.773 | −0.208 | 0.978 | 0.000 |
| | portion of first | | | | | | | | |
| | main scanning | | | | | | | | |
| | stop 40a | | | | | | | | |
| 7 | First | 26.000 | 1.000 | 0.535 | 0.660 | 0.000 | −0.777 | 0.629 | 0.000 |
| | deflecting | | | | | | | | |
| | surface 50a of | | | | | | | | |
| | deflecting unit | | | | | | | | |
| | 50 (in on-axis | | | | | | | | |
| | image height | | | | | | | | |
| | scanning) | | | | | | | | |
| 8 | Incident | 8.200 | 1.528 | −26.000 | 0.000 | 0.000 | −1.000 | 0.000 | 0.000 |
| | surface of | | | | | | | | |
| | upper portion | | | | | | | | |
| | 61a of first | | | | | | | | |
| | imaging | | | | | | | | |
| | optical | | | | | | | | |
| | element 60a | | | | | | | | |
| 9 | Exit surface | 69.300 | 1.000 | −34.200 | 0.000 | 0.000 | −1.000 | 0.000 | 0.000 |
| | of upper | | | | | | | | |
| | portion 61a of | | | | | | | | |
| | first imaging | | | | | | | | |
| | optical | | | | | | | | |
| | element 60a | | | | | | | | |
| 11 | Incident | 4.300 | 1.528 | −103.500 | 0.000 | 5.030 | −1.000 | 0.000 | 0.000 |
| | surface of | | | | | | | | |
| | second | | | | | | | | |
| | imaging | | | | | | | | |
| | optical | | | | | | | | |
| | element 80a | | | | | | | | |
| 12 | Exit surface | 10.670 | 1.000 | −107.800 | 0.000 | 5.030 | −1.000 | 0.000 | 0.000 |
| | of second | | | | | | | | |
| | imaging | | | | | | | | |
| | optical | | | | | | | | |
| | element 80a | | | | | | | | |
| 13 | Reflecting | 114.530 | 1.000 | −114.192 | 5.000 | 4.980 | −0.759 | 0.000 | 0.652 |
| | surface of first | | | | | | | | |
| | reflecting | | | | | | | | |
| | element 70a | | | | | | | | |
| 14 | First scanned | — | 1.000 | −97.695 | 0.000 | −112.686 | −0.151 | 0.000 | 0.989 |
| | surface 100a | | | | | | | | |
| | | | Refractive | | | | | | |
| | | Surface | index | | | | | | |
| Surface | | interval; | (λ = 790 | Coordinates of surface vertex | | | Direction cosine of optical axis | | |
| number | | [mm] | nm) | tc(x) | tc(y) | tc(z) | gx(x) | gx(y) | gx(z) |
| 1 | Second light | 0.250 | 1.000 | −33.582 | 157.991 | 7.617 | −0.208 | 0.977 | 0.047 |
| | source 10b | | | | | | | | |
| 2 | Glass cover | 33.340 | 1.511 | −33.530 | 157.747 | 7.605 | −0.208 | 0.977 | 0.047 |
| | for laser chip | | | | | | | | |
| 3 | Incident | 3.000 | 1.528 | −26.606 | 125.171 | 6.035 | −0.208 | 0.977 | 0.047 |
| | surface of | | | | | | | | |
| | upper portion | | | | | | | | |
| | 21au of first | | | | | | | | |
| | incident | | | | | | | | |
| | optical | | | | | | | | |
| | element 20a | | | | | | | | |
| 4 | Exit surface | 15.150 | 1.000 | −25.983 | 122.240 | 5.893 | −0.208 | 0.977 | 0.047 |
| | of lower | | | | | | | | |
| | portion 21au | | | | | | | | |
| | of first | | | | | | | | |
| | incident | | | | | | | | |
| | optical | | | | | | | | |
| | element 20a | | | | | | | | |
| 5 | Upper | 29.870 | 1.000 | −22.837 | 107.438 | 5.180 | −0.208 | 0.978 | 0.000 |
| | aperture | | | | | | | | |
| | portion 30au | | | | | | | | |
| | of first sub- | | | | | | | | |
| | scanning stop | | | | | | | | |
| | 30a | | | | | | | | |
| 6 | Aperture | 80.090 | 1.000 | −16.633 | 78.253 | 3.773 | −0.208 | 0.978 | 0.000 |
| | portion of first | | | | | | | | |
| | main scanning | | | | | | | | |
| | stop 40a | | | | | | | | |
| 7 | First | 26.000 | 1.000 | 0.535 | 0.660 | 0.000 | −0.777 | 0.629 | 0.000 |
| | deflecting | | | | | | | | |
| | surface 50a of | | | | | | | | |
| | deflecting unit | | | | | | | | |
| | 50 (in on-axis | | | | | | | | |
| | image height | | | | | | | | |
| | scanning) | | | | | | | | |
| 8 | Incident | 8.200 | 1.528 | −26.000 | 0.000 | 0.000 | −1.000 | 0.000 | 0.000 |
| | surface of | | | | | | | | |
| | lower portion | | | | | | | | |
| | 62a of first | | | | | | | | |
| | imaging | | | | | | | | |
| | optical | | | | | | | | |
| | element 60a | | | | | | | | |
| 9 | Exit surface | 48.348 | 1.000 | −34.200 | 0.000 | 0.000 | −1.000 | 0.000 | 0.000 |
| | of upper | | | | | | | | |
| | portion 62a of | | | | | | | | |
| | first imaging | | | | | | | | |
| | optical | | | | | | | | |
| | element 60a | | | | | | | | |
| 10 | Reflecting | 39.452 | 1.000 | −83.252 | 0.000 | −5.275 | −0.991 | 0.000 | 0.132 |
| | surface of first | | | | | | | | |
| | reflecting | | | | | | | | |
| | element 70b | | | | | | | | |
| 11 | Incident | 4.300 | 1.528 | −46.366 | 0.000 | −17.300 | −0.965 | 0.000 | 0.262 |
| | surface of | | | | | | | | |
| | second | | | | | | | | |
| | imaging | | | | | | | | |
| | optical | | | | | | | | |
| | element 80b | | | | | | | | |
| 12 | Exit surface | 4.523 | 1.000 | −42.216 | 0.000 | −18.427 | −0.965 | 0.000 | 0.262 |
| | of second | | | | | | | | |
| | imaging | | | | | | | | |
| | optical | | | | | | | | |
| | element 80b | | | | | | | | |
| 13 | Reflecting | 102.177 | 1.000 | −27.554 | −3.500 | −21.926 | −0.741 | 0.000 | −0.672 |
| | surface of | | | | | | | | |
| | second | | | | | | | | |
| | reflecting | | | | | | | | |
| | element 90a | | | | | | | | |
| 14 | Second | — | 1.000 | −14.695 | 0.000 | −112.686 | 0.167 | 0.000 | −0.986 |
| | scanned | | | | | | | | |
| | surface 100b | | | | | | | | |

TABLE 3-1

| | Aspherical coefficient | | | | | | |
|---|---|---|---|---|---|---|---|
| | | Lower portion 21al of | | Upper portion 61a of | | | |
| | | first incident optical | | first imaging optical | | Second imaging optical | |
| | | element 20a | | element 60a | | element 80a | |
| | | Incident | Exit | Incident | Exit | Incident | Exit |
| | Coefficient | surface | surface | surface | surface | surface | surface |
| Meridional | R | — | −3.717E+01 | −7.110E+01 | −4.295E+01 | 4.000E+03 | 3.501E+02 |
| line | K | — | — | 9.464E−01 | −5.155E−01 | — | −8.753E+01 |
| | B3 | — | — | — | — | — | — |
| | B4 | — | | −9.147E−07 | −3.477E−07 | — | −2.020E−07 |
| | B5 | — | — | — | — | — | — |
| | B6 | — | — | 6.784E−09 | 1.690E−09 | — | 1.609E−11 |
| | B7 | — | — | — | — | — | — |
| | B8 | — | — | −5.767E−12 | 1.110E−12 | — | −9.313E−16 |
| | B9 | — | — | — | — | — | — |
| | B10 | — | — | 1.638E−15 | −1.224E−15 | — | 2.524E−20 |
| Sagittal line | r | — | −2.617E+01 | 2.000E+01 | 2.500E+01 | 3.708E+01 | −1.540E+02 |
| | E1 | — | — | — | — | — | −1.278E−07 |
| | E2 | — | — | — | 1.522E−05 | −7.458E−07 | 1.813E−06 |
| | E3 | — | — | — | — | — | −3.240E−09 |
| | E4 | — | — | — | 8.486E−10 | — | −3.041E−10 |
| | E5 | — | — | — | — | — | 1.339E−12 |
| | E6 | — | — | — | −2.508E−11 | — | 3.082E−14 |
| | E7 | — | — | — | — | — | −2.009E−16 |
| | E8 | — | — | — | 7.607E−15 | — | −1.954E−18 |
| | E9 | — | — | — | — | — | 9.859E−21 |
| | E10 | — | — | — | 1.610E−17 | — | 5.812E−23 |
| Additional | M0_1 | — | — | — | −2.124E−02 | −1.007E−01 | 2.315E−02 |
| term | M1_1 | — | — | — | — | −2.129E−04 | −2.002E−04 |
| | M2_1 | — | — | — | 3.321E−05 | −1.314E−05 | −2.370E−05 |
| | M3_1 | — | — | — | — | 1.161E−07 | 1.056E−07 |
| | M4_1 | — | — | — | — | 1.765E−09 | 3.675E−09 |
| | M5_1 | — | — | — | — | −1.616E−11 | −1.409E−11 |
| | M6_1 | — | — | — | — | 3.014E−13 | −3.052E−13 |
| | M7_1 | — | — | — | — | 1.061E−15 | 9.733E−16 |
| | M8_1 | — | — | — | — | −1.306E−17 | 6.574E−17 |
| | M9_1 | — | — | — | — | −1.657E−20 | −1.728E−20 |
| | M10_1 | — | — | — | — | −8.536E−22 | −3.960E−21 |
| | C3 | −8.669E−03 | — | — | — | — | — |
| | C5 | −7.847E−03 | — | — | — | — | — |

TABLE 3-2

| | Aspherical coefficient | | | | | | |
|---|---|---|---|---|---|---|---|
| | | Upper portion 21au of | | Lower portion 62a of | | | |
| | | first incident optical | | first imaging optical | | Second imaging optical | |
| | | element 20a | | element 60a | | element 80b | |
| | | Incident | Exit | Incident | Exit | Incident | Exit |
| | Coefficient | surface | surface | surface | surface | surface | surface |
| Meridional | R | — | −3.717E+01 | −7.110E+01 | −4.380E+01 | 4.000E+03 | −3.800E+02 |
| line | K | — | — | 9.464E−01 | −9.321E−01 | — | −7.412E+01 |
| | B3 | — | — | — | — | — | — |
| | B4 | — | — | −9.147E−07 | −1.355E−06 | — | 1.332E−07 |
| | B5 | — | — | — | — | — | — |
| | B6 | — | — | 6.784E−09 | 1.719E−09 | — | −7.206E−12 |
| | B7 | — | — | — | — | — | — |
| | B8 | — | — | −5.767E−12 | 8.761E−13 | — | 3.070E−16 |
| | B9 | — | — | — | — | — | — |
| | B10 | — | — | 1.638E−15 | −1.069E−15 | — | −6.089E−21 |
| Sagittal line | r | — | −2.617E+01 | 2.000E+01 | 5.526E+01 | −3.743E+01 | 2.500E+02 |
| | E1 | — | — | — | — | — | −9.410E−09 |
| | E2 | — | — | — | 6.894E−06 | 3.482E−07 | −1.446E−06 |
| | E3 | — | — | — | — | — | 1.616E−09 |
| | E4 | — | — | — | 8.425E−08 | — | 2.793E−10 |
| | E5 | — | — | — | — | — | −4.721E−13 |
| | E6 | — | — | — | −2.679E−10 | — | −4.455E−14 |
| | E7 | — | — | — | — | — | 5.354E−17 |
| | E8 | — | — | — | 3.436E−13 | — | 3.936E−18 |
| | E9 | — | — | — | — | — | −2.027E−21 |
| | E10 | — | — | — | −1.539E−16 | — | −1.363E−22 |
| Additional | M0_1 | — | — | — | 7.661E−02 | −1.211E−01 | 5.801E−02 |
| term | M1_1 | — | — | — | — | −2.129E−04 | −2.002E−04 |
| | M2_1 | — | — | — | −3.906E−05 | −1.111E−05 | −2.292E−05 |
| | M3_1 | — | — | — | — | 1.419E−07 | 1.288E−07 |
| | M4_1 | — | — | — | — | 5.557E−10 | 2.627E−09 |
| | M5_1 | — | — | — | — | −2.589E−11 | −2.174E−11 |
| | M6_1 | — | — | — | — | 2.459E−13 | −2.067E−13 |
| | M7_1 | — | — | — | — | 2.150E−15 | 1.675E−15 |
| | M8_1 | — | — | — | — | −1.182E−17 | 3.209E−17 |
| | M9_1 | — | — | — | — | −6.130E−20 | −4.199E−20 |
| | M10_1 | — | — | — | — | −9.717E−23 | −1.487E−21 |
| | C3 | −8.669E−03 | — | — | — | — | — |
| | C5 | −7.847E−03 | — | — | — | — | — |

The upper portion 21au and the lower portion 21al of the first incident optical element 20a and the upper portion and the lower portion of the second incident optical element 20b which are provided in the light scanning apparatus 1 according to the present embodiment each have an incident surface that is a diffractive surface with a diffraction grating formed therein.

The first and second incident optical elements 20a and 20b are formed by injection molding that uses a plastic material as described above.

The light scanning apparatus 1 accordingly employs a so-called temperature-compensated optical system in which changes in refractive power of the first and second incident optical elements 20a and 20b due to environmental variation are compensated with changes in diffractive power of the diffractive surface that accompany changes in wavelength of the first to fourth light fluxes LA to LD in the first to fourth light sources 10a to 10d.

Specifically, the diffractive surface formed as the incident surface of each of the upper portion 21au and the lower portion 21al of the first incident optical element 20a and the upper portion and the lower portion of the second incident optical element 20b is defined by a phase function expressed by Expression (1) below.

$$ϕ = \frac{2 π M}{λ} ( {C}_{3} {Z}^{2} \times {C}_{5} {Y}^{2} ) \qquad ( 1 )$$

In Expression (1), ϕ represents the phase function, M represents order of diffraction, and λ represents a design wavelength and, because the light scanning apparatus 1 according to the present embodiment uses first-order diffraction light, M is 1 and λ is 790 nm.

The first imaging optical elements 60a and 60b and the second imaging optical elements 80a to 80d provided in the light scanning apparatus 1 according to the present embodiment have incident surfaces and exit surfaces each of which has a shape in the main scanning cross section (a meridional shape) which is an aspherical shape expressed by a tenth-order polynomial function.

Specifically, in each of the first imaging optical elements 60a and 60b and the second imaging optical elements 80a to 80d, an intersection (surface vertex) between an optical surface and an optical axis is set as an origin.

On each optical surface, a direction parallel to the optical axis, an axis perpendicular to the optical axis in the main scanning cross section, and an axis perpendicular to the optical axis in the sub-scanning cross section are set as an X-axis, a Y-axis, and a Z-axis, respectively.

In this case, the aspherical shape in the main scanning cross section of each of the incident surfaces and the exit surfaces of the first imaging optical elements 60a and 60b and the second imaging optical elements 80a to 80d is expressed by Expression (2) below.

$$X = \frac{\frac{{Y}^{2}}{R}}{1 + \sqrt{1 - ( 1 + K ) {( \frac{Y}{R} )}^{2}}} + {\sum }_{i = 1}^{10} {B}_{i} {Y}^{i} \qquad ( 2 )$$

In Expression (2), R represents a curvature radius (meridional curvature radius) in the main scanning cross section, K represents an eccentricity, and Bᵢ represents an aspherical coefficient.

A shape in the sub-scanning cross section (a sagittal shape) of each of the incident surfaces and the exit surfaces of the first imaging optical elements 60a and 60b and the second imaging optical elements 80a to 80d is expressed by Expression (3) below.

$$S = \frac{\frac{{Z}^{2}}{{r}^{′}}}{1 + \sqrt{1 - {( \frac{Z}{{r}^{′}} )}^{2}}} + {\sum }_{i = 0}^{16} {\sum }_{j = 1}^{8} {M}_{ij} {Y}^{i} {Z}^{j} \qquad ( 3 )$$

In Expression (3), S represents a shape (sagittal shape) in a section that includes a normal line of a meridional line at a predetermined position in the main scanning direction and that is perpendicular to the main scanning cross section, and Mᵢⱼ represents an aspherical coefficient.

A curvature radius r′ in the sub-scanning cross section (a sagittal curvature radius) at a position spaced apart from the optical axis by Y in the main scanning direction is expressed by Expression (4) below.

$$\frac{1}{{r}^{′}} = \frac{1}{r} + {\sum }_{i = 1}^{10} {E}_{i} {Y}^{i} \qquad ( 4 )$$

In Expression (4), “r” represents a sagittal curvature radius on the optical axis, and Eᵢ represents a sagittal variation coefficient.

In the light scanning apparatus 1 according to the present embodiment, the shape of the optical surface of each optical element is defined by the functions expressed in Expressions (1) to (4) above, but are not limited thereto and may be defined by other functions.

As illustrated in FIG. 1A and FIG. 1B, in the light scanning apparatus 1 according to the present embodiment, the first and second light fluxes LA and LB travel through the first imaging optical element 60a shared by the first and second light fluxes LA and LB, and the third and fourth light fluxes LC and LD travel through the first imaging optical element 60b shared by the third and fourth light fluxes LC and LD.

Specifically, the first and second light fluxes LA and LB travel through the upper portion 61a and the lower portion 62a, respectively, of the first imaging optical element 60a in the sub-scanning direction.

The third and fourth light fluxes LC and LD travel through the upper portion and the lower portion, respectively, of the first imaging optical element 60b in the sub-scanning direction.

The upper portion and the lower portion in the sub-scanning direction here may also be referred to as “opposite scanned surface-side portion,” which is on a side opposite to the scanned surface in the sub-scanning direction, and “scanned surface-side portion,” respectively.

As shown in Table 3-1 and Table 3-2, the shape of the exit surface of the first imaging optical element 60a is defined so as to differ between the upper portion 61a through which the first light flux LA travels and the lower portion 62a through which the second light flux LB travels.

That is, despite being a single optical element, the first imaging optical element 60a is shaped to have a multi-stage configuration in which the shape of the exit surface differs between the upper portion 61a and the lower portion 62a in the sub-scanning direction, and the first imaging optical element 60b has a similar configuration as well.

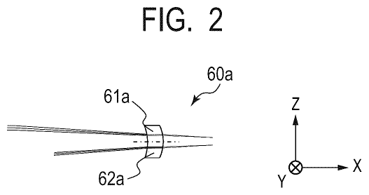

FIG. 2 shows a sub-scanning cross sectional view of the first imaging optical element 60a provided in the light scanning apparatus 1 according to the present embodiment.

As illustrated in FIG. 2, the first imaging optical element 60a has, on respective sides of a center line indicated by the broken line in the sub-scanning direction, the upper portion 61a through which the first light flux LA travels and the lower portion 62a through which the second light flux LB travels.

The upper portion 61a and the lower portion 62a of the first imaging optical element 60a respectively have exit surfaces formed to have shapes as shown in Table 3-1 and Table 3-2.

This enables the first imaging optical element 60a to efficiently condense both of the first and second light fluxes LA and LB emitted from the first and second light sources 10a and 10b, respectively.

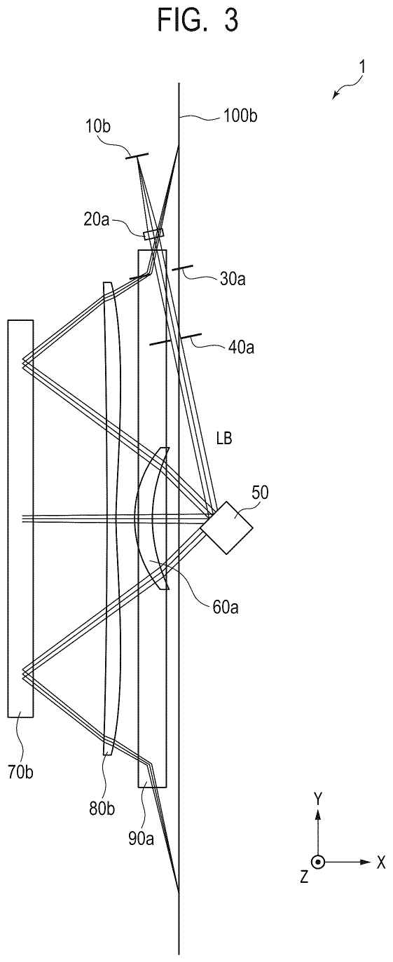

FIG. 3 shows a partial projected view in the main scanning cross section of the light scanning apparatus 1 according to the present embodiment.

Specifically, the second incident optical system, the second imaging optical system, the first reflecting element 70b, and the second reflecting element 90a which form an optical path of the second light flux LB are illustrated in FIG. 3.

In the light scanning apparatus 1 according to the present embodiment, the use of the plurality of reflecting elements causes optical paths of the first to fourth light fluxes LA to LD to fold in the sub-scanning direction, and downsizing of the housing 2 and shortening of a distance (drum pitch) between adjacent scanned surfaces can thus be accomplished.

As a result, when being projected in the main scanning cross section as illustrated in FIG. 3, the first incident optical element 20a and an end portion of the second reflecting element 90a in a longitudinal direction are arranged in very close proximity to each other.

In other words, the first incident optical element 20a and the second reflecting element 90a are placed in a first region and a second region, respectively, in the X-direction, and at least a part of the first region and at least a part of the second region overlap with each other.

To paraphrase further, when being projected in the main scanning cross section, the first incident optical element 20a is placed on an extended line in a direction in which the second reflecting element 90a extends (the Y-direction).

Arrangement in which a plurality of optical elements are in too close proximity to one another like this is not preferred in view of outer shapes of the respective optical elements and space in which holding portions for holding the respective optical elements are to be formed.

On the other hand, the first incident optical element 20a in the light scanning apparatus 1 according to the present embodiment is placed in a manner that is advantageous from the viewpoint of overall optical performance of the apparatus, error sensitivity, and the like, and optical arrangement illustrated in FIG. 3 is accordingly optically preferred.

Next, a specific shape of the first and second incident optical elements 20a and 20b provided in the light scanning apparatus 1 according to the present embodiment is described.

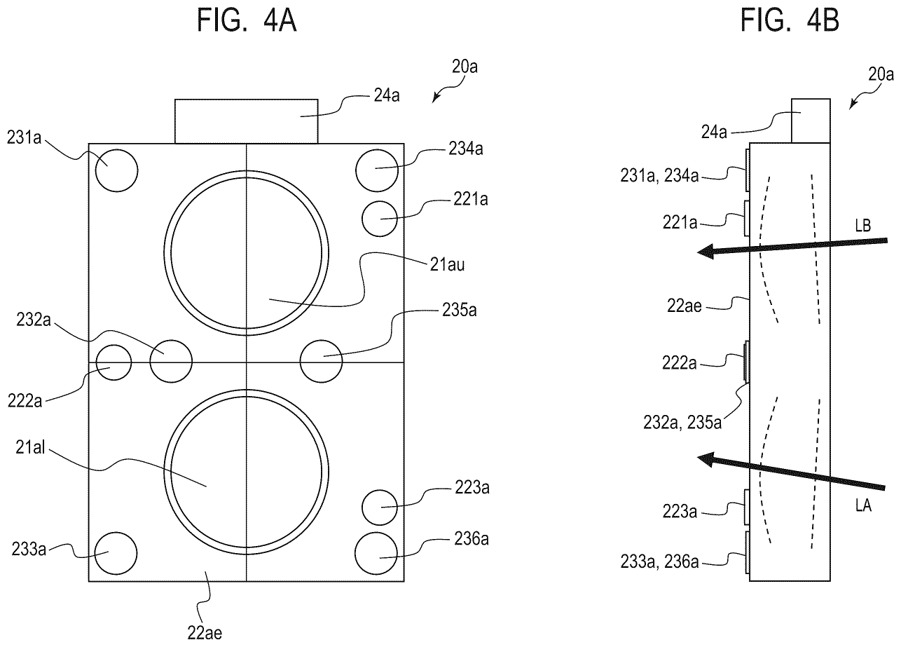

FIG. 4A and FIG. 4B show a frontal view and a side-elevational view, respectively, of the first incident optical element 20a provided in the light scanning apparatus 1 according to the present embodiment.

The two arrows illustrated in FIG. 4B indicate traveling directions of the first and second light fluxes LA and LB, respectively, and the broken lines illustrated in FIG. 4B schematically indicate shapes of respective optical surfaces in the sub-scanning cross section.

The first and the second incident optical elements 20a and 20b have shapes identical to each other, and, accordingly, the shape of the first incident optical element 20a alone is described below.

As illustrated in FIG. 4A and FIG. 4B, the first incident optical element 20a provided in the light scanning apparatus 1 according to the present embodiment is a so-called two-lens element formed from the upper portion 21au and the lower portion 21al which are placed at positions different from each other in the sub-scanning direction.

That is, in the first incident optical element 20a, the upper portion 21au and the lower portion 21al are integrally formed with each other.

The lower portion 21al and the upper portion 21au can condense the first and second light fluxes LA and LB, respectively, which have been emitted from the first and second light sources 10a and 10b, respectively.

The first incident optical element 20a is also provided with a plurality of reference surfaces 221a, 222a, and 223a (a second protruding portion group) for positioning in an optical axis direction of the first incident optical element 20a.

Specifically, the plurality of reference surfaces 221a to 223a are formed as protruding portions protruding outward from an outer shape surface 22ae on an exit surface side of a non-effective region which is around the upper portion 21au and the lower portion 21al and through which the first and second light fluxes LA and LB do not travel.

As described later, the plurality of reference surfaces 221a to 223a abut against a holding portion (projecting portion) 2p provided in the housing 2, to thereby determine a position of the first incident optical element 20a in the optical axis direction.

As described above, the first incident optical element 20a is formed by injection molding of a plastic material injected from a gate portion 24a.

For that reason, as illustrated in FIG. 4A, the first incident optical element 20a is provided with a plurality of pressed surfaces 231a, 232a, 233a, 234a, 235a, and 236a pressed by ejector pins when the first incident optical element 20a is released from a mold.

Specifically, the plurality of pressed surfaces 231a to 236a (a third protruding portion group) are formed as protruding portions protruding outward from the outer shape surface 22ae, similarly to the plurality of reference surfaces 221a to 223a.

A protrusion amount of each of the plurality of pressed surfaces 231a to 236a, on the other hand, is smaller than a protrusion amount of each of the plurality of reference surfaces 221a to 223a.

That is, the plurality of pressed surfaces 231a to 236a do not contribute to the positioning of the first incident optical element 20a in the optical axis direction.

In the first incident optical element 20a, some of the plurality of pressed surfaces 231a to 236a, specifically, a plurality of pressed surfaces 231a, 233a, 234a, and 236a, are formed so as to be closer to the outside in the sub-scanning direction than the plurality of reference surfaces 221a to 223a are.

With the plurality of pressed surfaces 231a, 233a, 234a, and 236a formed so as to be closer to the outside in the sub-scanning direction than the plurality of reference surfaces 221a to 223a are, a change in shape that leads to a molding defect when the first incident optical element 20a is released can be suppressed.

Next, holding of the first incident optical element 20a and the second reflecting element 90a in the light scanning apparatus 1 according to the present embodiment is described.

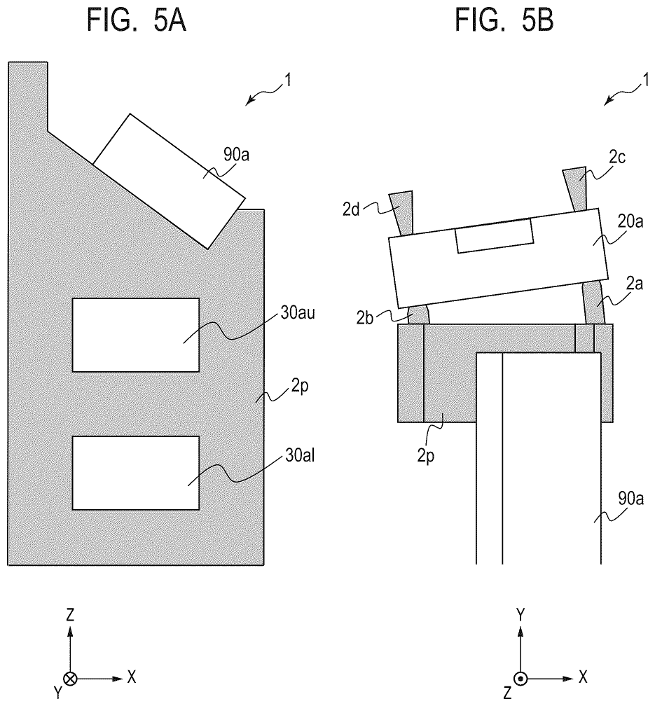

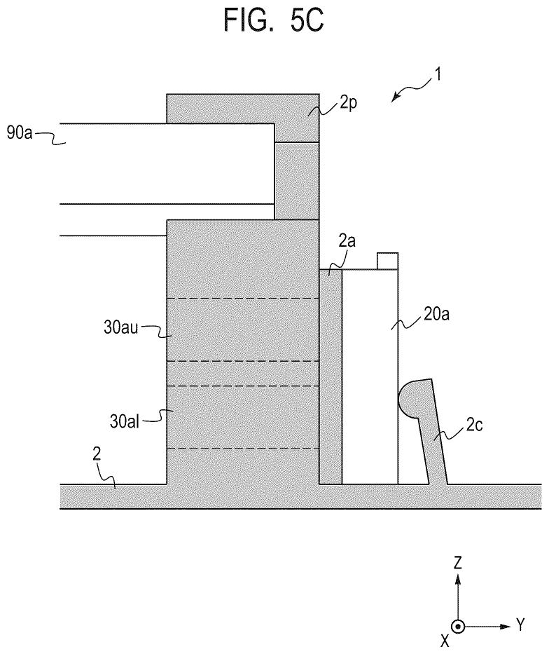

FIG. 5A, FIG. 5B, and FIG. 5C show a view of the vicinity of the first incident optical element 20a (an optical element) of the light scanning apparatus 1 according to the present embodiment as viewed from the optical axis direction, a view of the vicinity viewed from the main scanning direction, and a view of the vicinity viewed from the sub-scanning direction, respectively.

In the light scanning apparatus 1 according to the present embodiment, as illustrated in FIG. 5A, FIG. 5B, and FIG. 5C, the projecting portion 2p which projects in the sub-scanning direction and which is unitary with the first sub-scanning stop 30a is integrally formed in the housing 2.

In other words, the housing 2 includes a box portion having an internal space in which the optical elements are placed and a lid portion covering the internal space, and the projecting portion 2p projects in the sub-scanning direction from a predetermined position on a bottom surface of the box portion.

To paraphrase further, the projecting portion 2p is formed from the same material as a material of the rest of the housing 2.

The direction in which the projecting portion 2p projects is not limited to the sub-scanning direction, and the projecting portion 2p may project in a direction that is not parallel to the sub-scanning direction, such as a direction including a component of the sub-scanning direction.

The plurality of reference surfaces 221a to 223a formed on the outer shape surface 22ae on the exit surface side of the first incident optical element 20a abut against the projecting portion 2p in the main scanning direction (Y-direction).

Specifically, on a surface (first surface) of the projecting portion 2p that is perpendicular to an optical axis of the first incident optical system, two protruding portions 2a and 2b extending in the sub-scanning direction are formed on two sides of the optical axis direction (X-direction) of the first to fourth imaging optical systems with respect to the upper aperture portion 30au and the lower aperture portion 30al of the first sub-scanning stop 30a.

The plurality of reference surfaces 221a to 223a abut against the two protruding portions 2a and 2b (a first protruding portion group).

In the light scanning apparatus 1 according to the present embodiment, as illustrated in FIG. 5C, the two protruding portions 2a and 2b have lengths different from each other in the main scanning cross section.

As illustrated in FIG. 5A and FIG. 5B, biasing portions 2c and 2d integrally formed with the housing 2 bias the first incident optical element 20a toward the protruding portions 2a and 2b of the projecting portion 2p.

As described above, with the first incident optical element 20a biased in the optical axis direction toward the protruding portions 2a and 2b of the projecting portion 2p by the biasing portions 2c and 2d, the position of the first incident optical element 20a in the optical axis direction is determined.

That is, in the light scanning apparatus 1 according to the present embodiment, the first incident optical element 20a is held by the projecting portion 2p and the biasing portions 2c and 2d.

As illustrated in FIG. 5A to FIG. 5C, the second reflecting element 90a (reflecting optical element) abuts against the projecting portion 2p as well in the sub-scanning direction (Z-direction).

Specifically, the second reflecting element 90a is placed on a concave portion formed on a surface (second surface) of the projecting portion 2p that is parallel to the optical axis of the first incident optical system, and is biased toward the concave portion by a biasing member (not shown).

That is, in the light scanning apparatus 1 according to the present embodiment, the second reflecting element 90a is held by the projecting portion 2p and the biasing member.

The projecting portion 2p may be formed so that the second reflecting element 90a abuts against the projecting portion 2p in the main scanning direction (Y-direction) as required.

In the light scanning apparatus 1 according to the present embodiment, by employing the configuration described above, the first incident optical element 20a can be held despite the closeness of the first incident optical element 20a and the second reflecting element 90a to each other in the main scanning cross section.

That is, in the light scanning apparatus 1 according to the present embodiment, the first incident optical element 20a can be supported so as to be fixed without providing a separate support member for supporting the first incident optical element 20a.

In the light scanning apparatus 1 according to the present embodiment, as illustrated in FIG. 5A to FIG. 5C, both of the first incident optical element 20a and the second reflecting element 90a can be held with use of the shared projecting portion 2p.

Accordingly, compared to a case in which a holding portion for holding the first incident optical element 20a and a holding portion for holding the second reflecting element 90a are formed spaced apart from each other, a shape of the housing 2 can be simplified.

In addition, in the light scanning apparatus 1 according to the present embodiment, as illustrated in FIG. 5A and FIG. 5C, the holding portion for holding the first incident optical element 20a, the holding portion for holding the second reflecting element 90a, and the first sub-scanning stop 30a are integrally formed as the projecting portion 2p.

Accordingly, in the light scanning apparatus 1 according to the present embodiment, the shape of the housing 2 can be simplified.

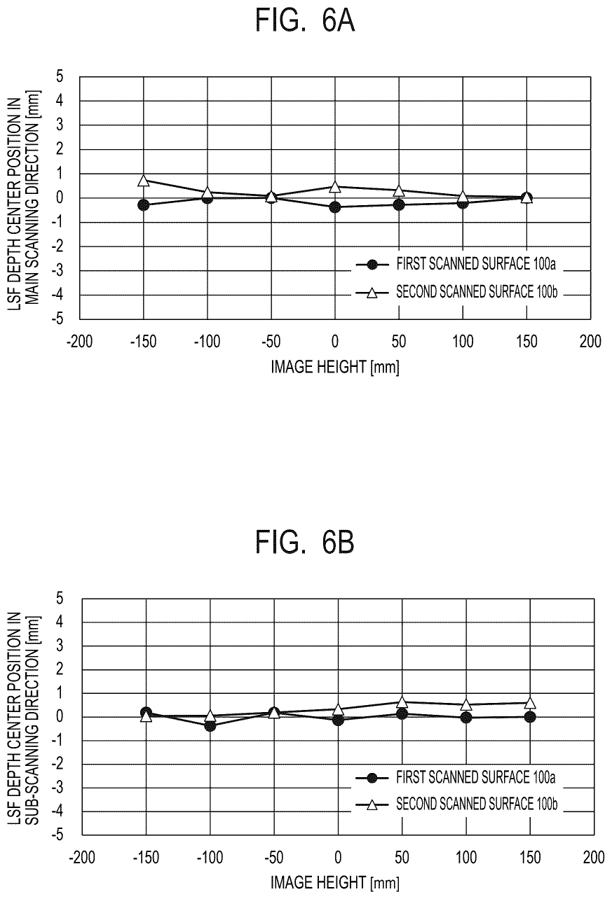

FIG. 6A and FIG. 6B show image height dependence of a line-spread function (LSF) depth center position in the main scanning direction and an LSF depth center position in the sub-scanning direction, respectively, on each scanned surface in the light scanning apparatus 1 according to the present embodiment.

The LSF depth center position in the main scanning direction and the LSF depth center position in the sub-scanning direction here refer to center positions of regions in which LSF widths in the main scanning direction and the sub-scanning direction, respectively, are equal to or less than a slice level, when defocusing in the optical axis direction in the vicinity of a predetermined scanned surface.

In the light scanning apparatus 1 according to the present embodiment, in both of the main scanning direction and the sub-scanning direction, the slice level is set to 120 μm for entire image heights.

The LSF width in the main scanning direction and the LSF width in the sub-scanning direction refer to widths of slices of light amount profiles obtained by integrating spot profiles at each image height in the sub-scanning direction and the main scanning direction, respectively, when the light amount profiles are sliced at a position that is 13.5% of a maximum value.

As shown in FIG. 6A and FIG. 6B, the LSF depth center position in the main scanning direction and the LSF depth center position in the sub-scanning direction both fall within +1 mm for all image heights, and this shows that excellent imaging performance is achieved in the light scanning apparatus 1 according to the present embodiment.

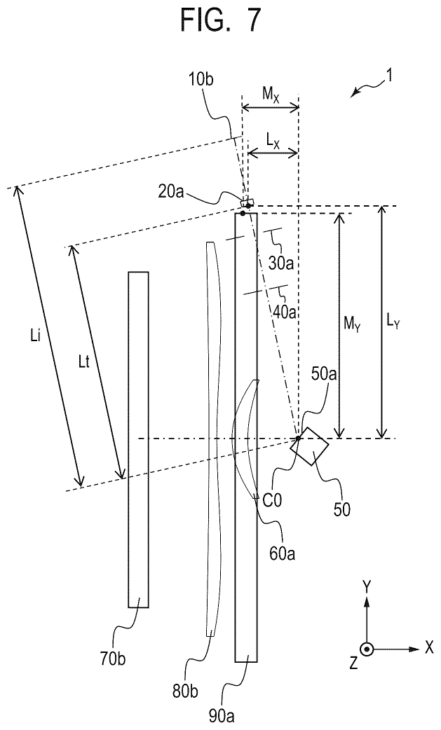

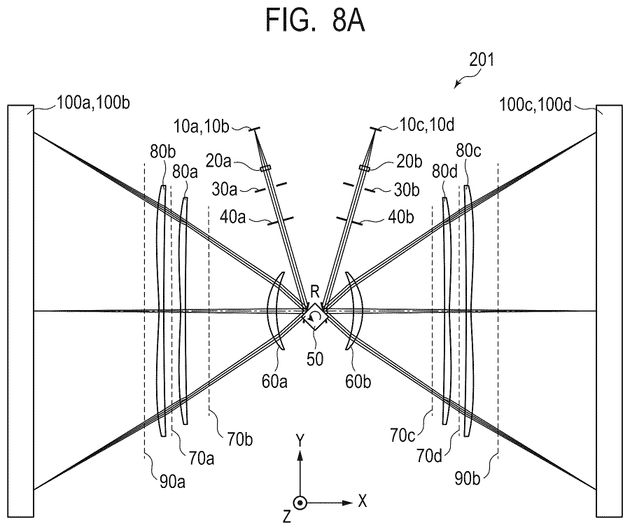

FIG. 7 shows a partial projected view in the main scanning cross section for illustrating inequalities in the light scanning apparatus 1 according to the present embodiment.

First, a distance in the X-direction between the on-axis deflection point C0 on the first deflecting surface 50a of the deflecting unit 50 and a center of the outer shape surface 22ae of the first incident optical element 20a on which the plurality of reference surfaces 221a to 223a are formed is represented by Lx.

The on-axis deflection point C0 here refers to a deflection point on the first deflecting surface 50a of principal rays of the first and second light fluxes LA and LB deflected by the deflecting unit 50 so that on-axis image heights on the first and second scanned surfaces 100a and 100b are scanned with the first and second light fluxes LA and LB.

A distance in the X-direction between the on-axis deflection point C0 and a center of the reflecting surface of the second reflecting element 90a is represented by M_{X}.

In this case, it is preferred that the following Inequality (5) is satisfied in the light scanning apparatus 1 according to the present embodiment.

$$0.5 < {M}_{X} / {L}_{X} < 1.5 \qquad ( 5 )$$

When the ratio exceeds the upper limit value in Inequality (5), the second reflecting element 90a is separated too far from the deflecting unit 50 in the main scanning cross section, which makes it difficult to shorten an interval between adjacent scanned surfaces, that is, to downsize the light scanning apparatus 1 according to the present embodiment, so that it is unpreferable.

When the ratio falls below the lower limit value in Inequality (5), on the other hand, the second reflecting element 90a is too close to the deflecting unit 50 in the main scanning cross section. Accordingly, the second reflecting element 90a may interfere with at least one optical element provided in the third and fourth imaging optical systems on the opposite side with respect to the deflecting unit 50.

Then, when the second reflecting element 90a and the at least one optical element are separated from each other in the sub-scanning direction in order to suppress such interference, the light scanning apparatus 1 according to the present embodiment increases in size in the sub-scanning direction, so that it is unpreferable.

In the light scanning apparatus 1 according to the present embodiment, it is more preferred that the following Inequality (5a) be satisfied.

$$0.7 < {M}_{X} / {L}_{X} < 1.4 \qquad ( 5 a )$$

A distance in the Y-direction between the on-axis deflection point C0 and the center of the outer shape surface 22ae of the first incident optical element 20a on which the plurality of reference surfaces 221a to 223a are formed is represented by L_{Y}.

A distance in the Y-direction between the on-axis deflection point C0 and the end portion of the second reflecting element 90a that is closest to the first incident optical element 20a is represented by M_{Y}.

In this case, it is preferred that the following Inequality (6) is satisfied in the light scanning apparatus 1 according to the present embodiment.

$$0.9 < {M}_{Y} / {L}_{Y} < 0.97 \qquad ( 6 )$$

When the ratio exceeds the upper limit value in Inequality (6), too close proximity of the first incident optical element 20a and the second reflecting element 90a to each other may cause interference therebetween, so that it is unpreferable.

When the ratio falls below the lower limit value in Inequality (6), on the other hand, the first incident optical element 20a and the second reflecting element 90a are separated too far from each other. This causes an increase in size of the light scanning apparatus 1 according to the present embodiment, so that it is unpreferable.

In addition, when the ratio falls below the lower limit value in Inequality (6), it is required to provide the holding portion for holding the first incident optical element 20a and the holding portion for holding the second reflecting element 90a so as to be separated from each other, instead of the single projecting portion 2p. This complicates the structure of the housing 2, so that it is unpreferable.

In the light scanning apparatus 1 according to the present embodiment, it is more preferred that the following Inequality (6a) is satisfied.

$$0.93 < {M}_{Y} / {L}_{Y} < 0.97 \qquad ( 6 a )$$

A distance in the main scanning cross section (the XY section) between the on-axis deflection point C0 and the center of the outer shape surface 22ae of the first incident optical element 20a on which the plurality of reference surfaces 221a to 223a are formed is represented by Lₜ.

A distance between the first and second light sources 10a and 10b, and the on-axis deflection point C0 in the optical axis direction of the first and second incident optical systems (the optical axis direction of the first incident optical element 20a) is represented by Li.

In this case, it is preferred that the following Inequality (7) is satisfied in the light scanning apparatus 1 according to the present embodiment.

$$0.7 < {L}_{t} / {L}_{i} < 0.9 \qquad ( 7 )$$

When the ratio exceeds the upper limit value in Inequality (7), the first incident optical element 20a and the second reflecting element 90a are separated too far from each other. Accordingly, it is required to provide the holding portion for holding the first incident optical element 20a and the holding portion for holding the second reflecting element 90a so as to be separated from each other, instead of the single projecting portion 2p. This complicates the structure of the housing 2, so that it is unpreferable.

When the ratio falls below the lower limit value in Inequality (7), on the other hand, optical efficiency in the light scanning apparatus 1 according to the present embodiment drops, specifically, light amounts of the first and second light fluxes LA and LB that reach the first and second scanned surfaces 100a and 100b, respectively, decrease, so that it is unpreferable.

In the light scanning apparatus 1 according to the present embodiment, it is more preferred that the following Inequality (7a) is satisfied.

$$0.75 < {L}_{t} / {L}_{i} < 0.85 \qquad ( 7 a )$$

In the light scanning apparatus 1 according to the present embodiment, as shown in Table 1 and Table 10, which is described later, Inequalities (5), (5a), (6), (6a), (7), and (7a) are satisfied.

As described above, in the light scanning apparatus 1 according to the present embodiment, the first incident optical element 20a and the second reflecting element 90a are held by the projecting portion 2p integrally formed with the housing 2.

Both of the first incident optical element 20a and the second reflecting element 90a can thus be held with a simple configuration when downsizing is to be achieved by placing the first incident optical element 20a and the second reflecting element 90a close to each other.

That is, in the light scanning apparatus 1 according to the present embodiment, the number of components can be reduced by holding the first incident optical element 20a and the second reflecting element 90a by the projecting portion 2p, which is integrally formed with the housing 2, instead of using separate holding members.

### Second Embodiment

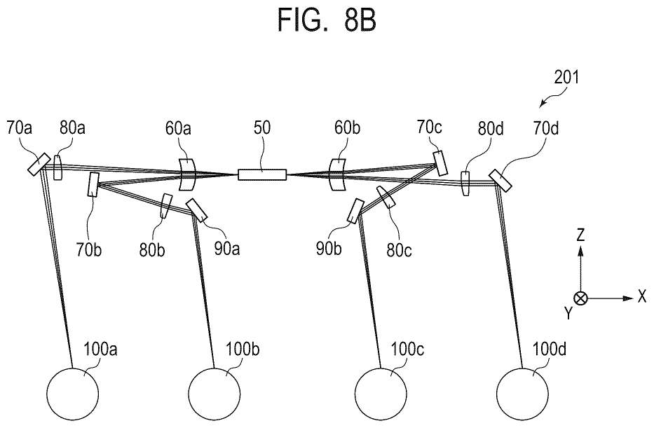

FIG. 8A and FIG. 8B show a developed view (corresponding to FIG. 1A) in a main scanning cross section of a light scanning apparatus 201 according to a second embodiment of the present invention, and a partial sub-scanning cross sectional view (corresponding to FIG. 1B) thereof, respectively.

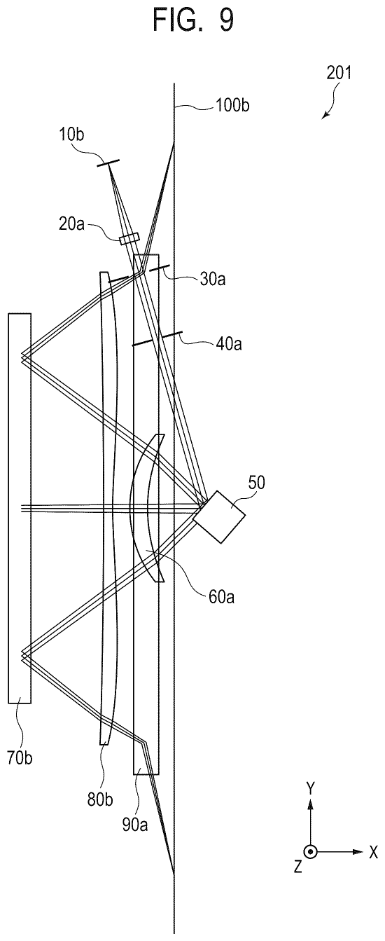

FIG. 9 shows a partial projected view (corresponding to FIG. 3) in the main scanning cross section of the light scanning apparatus 201 according to the second embodiment.

The light scanning apparatus 201 according to the present embodiment has the same configuration as that of the light scanning apparatus 1 according to the first embodiment, except for differences in various numerical values. Accordingly, the same members are denoted by the same reference numbers, and descriptions thereof are omitted.

Specification values of the light scanning apparatus 201 according to the present embodiment, refractive indices and coordinates of the respective optical elements, and shapes of optical surfaces of the respective optical elements are shown in Table 4, Table 5, and Table 6-1 and Table 6-2, respectively.

In Table 5, Table 6-1, and Table 6-2, information about only the first and second incident optical systems and the first and second imaging optical systems is shown. That is, in Table 5, Table 6-1, and Table 6-2, information about the third and fourth incident optical systems and the third and fourth imaging optical systems is omitted.

TABLE 4

| | Parameter · | |
|---|---|---|
| Item | Unit | Value |
| Wavelength used by first to fourth | λ [nm] | 790 |
| light sources 10a to 10d | | |
| Scanning width of first to fourth | h [mm] | 326 |
| scanned surfaces 100a to 100d | | |
| Number of deflecting surfaces of | [Surface] | 4 |
| deflecting unit 50 | | |
| Circumscribed circle diameter of | Pd [mm] | 20 |
| deflecting unit 50 | | |
| Maximum scanning angle of | θmax [rad] | 0.787 |
| deflecting unit 50 | | |
| Rotation center coordinates of | (X, Y) [mm] | (6.10, −3.66) |
| deflecting unit 50 | | |
| Absolute value of incident angle of first | θim [deg] | 74.00 |
| to fourth incident optical systems in | | |
| main scanning cross section | | |
| Absolute value of incident angle of first | θis [deg] | 2.70 |
| to fourth incident optical systems in | | |
| sub-scanning cross section | | |
| Width of respective aperture portions | As [mm] | 2.84 |
| of first and second sub-scanning stops | | |
| 30a and 30b in sub-scanning direction | | |
| Width of respective aperture portions | Am [mm] | 3.75 |
| of first and second main scanning stops | | |
| 40a and 40b in main scanning direction | | |
| Distance in X-direction between | Lx [mm] | 34.45 |
| on-axis deflection point C0 and centers of | | |
| exit surfaces of first and second incident | | |
| optical elements 20a and 20b | | |
| Distance in Y-direction between | Ly [mm] | 120.13 |
| on-axis deflection point C0 and centers | | |
| of exit surfaces of first and second incident | | |
| optical elements 20a and 20b | | |
| Distance in XY cross section between | Lt [mm] | 125.11 |
| on-axis deflection point C0 and centers of | | |
| exit surfaces of first and second incident | | |
| optical elements 20a and 20b | | |
| Distance in optical axis | Li [mm] | 161.70 |
| direction of first to fourth incident optical | | |
| systems between first to fourth light | | |
| sources 10a to 10d and on-axis | | |
| deflection point C0 | | |
| Distance in X-direction between | Mx [mm] | 27.55 |
| on-axis deflection point C0 and centers | | |
| of reflecting surfaces of | | |
| second reflecting elements 90a and 90b | | |
| Distance in Y-direction between | My [mm] | 116.50 |
| on-axis deflection point C0 and centers | | |
| of reflecting surfaces of | | |
| second reflecting elements 90a and 90b | | |

TABLE 5

| | | | Refractive | | | | | | |
|---|---|---|---|---|---|---|---|---|---|
| | | Surface | index | | | | | | |
| Surface | | interval | (λ = 790 | Coordinates of surface vertex | | | Direction cosine of optical axis | | |
| number | | [mm] | nm) | tc(x) | tc(y) | tc(z) | gx(x) | gx(y) | gx(z) |
| 1 | First light | 0.250 | 1.000 | −44.521 | 155.263 | −7.617 | −0.275 | 0.960 | −0.047 |
| | source 10a | | | | | | | | |
| 2 | Glass cover | 33.340 | 1.511 | −44.452 | 155.023 | −7.605 | −0.275 | 0.960 | −0.047 |
| | for laser chip | | | | | | | | |
| 3 | Incident | 3.000 | 1.528 | −35.273 | 123.011 | −6.035 | −0.275 | 0.960 | −0.047 |
| | surface of | | | | | | | | |
| | lower portion | | | | | | | | |
| | 21al of first | | | | | | | | |
| | incident | | | | | | | | |
| | optical | | | | | | | | |
| | element 20a | | | | | | | | |
| 4 | Exit surface | 15.150 | 1.000 | −34.447 | 120.130 | −5.893 | −0.275 | 0.960 | −0.047 |
| | of lower | | | | | | | | |
| | portion 21al | | | | | | | | |
| | of first | | | | | | | | |
| | incident | | | | | | | | |
| | optical | | | | | | | | |
| | element 20a | | | | | | | | |
| 5 | Lower | 29.870 | 1.000 | −30.275 | 105.583 | −5.180 | −0.276 | 0.961 | 0.000 |
| | aperture | | | | | | | | |
| | portion 30al | | | | | | | | |
| | of first sub- | | | | | | | | |
| | scanning stop | | | | | | | | |
| | 30a | | | | | | | | |
| 6 | Aperture | 80.090 | 1.000 | −22.051 | 76.902 | −3.773 | −0.276 | 0.961 | 0.000 |
| | portion of first | | | | | | | | |
| | main scanning | | | | | | | | |
| | stop 40a | | | | | | | | |
| 7 | First | 26.000 | 1.000 | 0.451 | 0.598 | 0.000 | −0.799 | 0.602 | 0.000 |
| | deflecting | | | | | | | | |
| | surface 50a of | | | | | | | | |
| | deflecting unit | | | | | | | | |
| | 50 (in on-axis | | | | | | | | |
| | image height | | | | | | | | |
| | scanning) | | | | | | | | |
| 8 | Incident | 8.200 | 1.528 | −26.000 | 0.000 | 0.000 | −1.000 | 0.000 | 0.000 |
| | surface of | | | | | | | | |
| | upper portion | | | | | | | | |
| | 61a of first | | | | | | | | |
| | imaging | | | | | | | | |
| | optical | | | | | | | | |
| | element 60a | | | | | | | | |
| 9 | Exit surface | 69.300 | 1.000 | −34.200 | 0.000 | 0.000 | −1.000 | 0.000 | 0.000 |
| | of upper | | | | | | | | |
| | portion 61a of | | | | | | | | |
| | first imaging | | | | | | | | |
| | optical | | | | | | | | |
| | element 60a | | | | | | | | |
| 11 | Incident | 4.300 | 1.528 | −103.500 | 0.000 | 5.030 | −1.000 | 0.000 | 0.000 |
| | surface of | | | | | | | | |
| | second | | | | | | | | |
| | imaging | | | | | | | | |
| | optical | | | | | | | | |
| | element 80a | | | | | | | | |
| 12 | Exit surface | 10.670 | 1.000 | −107.800 | 0.000 | 5.030 | −1.000 | 0.000 | 0.000 |
| | of second | | | | | | | | |
| | imaging | | | | | | | | |
| | optical | | | | | | | | |
| | element 80a | | | | | | | | |
| 13 | Reflecting | 114.530 | 1.000 | −114.192 | 5.000 | 4.980 | −0.759 | 0.000 | 0.652 |
| | surface of first | | | | | | | | |
| | reflecting | | | | | | | | |
| | element 70a | | | | | | | | |
| 14 | First scanned | — | 1.000 | −97.695 | 0.000 | −112.686 | −0.151 | 0.000 | 0.989 |
| | surface 100a | | | | | | | | |
| 1 | Second light | 0.250 | 1.000 | −44.521 | 155.263 | 7.617 | −0.275 | 0.960 | 0.047 |
| | source 10b | | | | | | | | |
| 2 | Glass cover | 33.340 | 1.511 | −44.452 | 155.023 | 7.605 | −0.275 | 0.960 | 0.047 |
| | for laser chip | | | | | | | | |
| 3 | Incident | 3.000 | 1.528 | −35.273 | 123.011 | 6.035 | −0.275 | 0.960 | 0.047 |
| | surface of | | | | | | | | |
| | upper portion | | | | | | | | |
| | 21au of first | | | | | | | | |
| | incident | | | | | | | | |
| | optical | | | | | | | | |
| | element 20a | | | | | | | | |
| 4 | Exit surface | 15.150 | 1.000 | −34.447 | 120.130 | 5.893 | −0.275 | 0.960 | 0.047 |
| | of lower | | | | | | | | |
| | portion 21au | | | | | | | | |
| | of first | | | | | | | | |
| | incident | | | | | | | | |
| | optical | | | | | | | | |
| | element 20a | | | | | | | | |
| 5 | Upper | 29.870 | 1.000 | −30.275 | 105.583 | 5.180 | −0.276 | 0.961 | 0.000 |
| | aperture | | | | | | | | |
| | portion 30au | | | | | | | | |
| | of first sub- | | | | | | | | |
| | scanning stop | | | | | | | | |
| | 30a | | | | | | | | |
| 6 | Aperture | 80.090 | 1.000 | −22.051 | 76.902 | 3.773 | −0.276 | 0.961 | 0.000 |
| | portion of first | | | | | | | | |
| | main scanning | | | | | | | | |
| | stop 40a | | | | | | | | |
| 7 | First | 26.000 | 1.000 | 0.451 | 0.598 | 0.000 | −0.799 | 0.602 | 0.000 |
| | deflecting | | | | | | | | |
| | surface 50a of | | | | | | | | |
| | deflecting unit | | | | | | | | |
| | 50 (in on-axis | | | | | | | | |
| | image height | | | | | | | | |
| | scanning) | | | | | | | | |
| 8 | Incident | 8.200 | 1.528 | −26.000 | 0.000 | 0.000 | −1.000 | 0.000 | 0.000 |
| | surface of | | | | | | | | |
| | lower portion | | | | | | | | |
| | 62a of first | | | | | | | | |
| | imaging | | | | | | | | |
| | optical | | | | | | | | |
| | element 60a | | | | | | | | |
| 9 | Exit surface | 48.348 | 1.000 | −34.200 | 0.000 | 0.000 | −1.000 | 0.000 | 0.000 |
| | of upper | | | | | | | | |
| | portion 62a of | | | | | | | | |
| | first imaging | | | | | | | | |
| | optical | | | | | | | | |
| | element 60a | | | | | | | | |
| 10 | Reflecting | 39.452 | 1.000 | −83.252 | 0.000 | −5.275 | −0.991 | 0.000 | 0.132 |
| | surface of first | | | | | | | | |
| | reflecting | | | | | | | | |
| | element 70b | | | | | | | | |
| 11 | Incident | 4.300 | 1.528 | −46.366 | 0.000 | −17.300 | −0.965 | 0.000 | 0.262 |
| | surface of | | | | | | | | |
| | second | | | | | | | | |
| | imaging | | | | | | | | |
| | optical | | | | | | | | |
| | element 80b | | | | | | | | |
| 12 | Exit surface | 4.523 | 1.000 | −42.216 | 0.000 | −18.427 | −0.965 | 0.000 | 0.262 |
| | of second | | | | | | | | |
| | imaging | | | | | | | | |
| | optical | | | | | | | | |
| | element 80b | | | | | | | | |
| 13 | Reflecting | 102.177 | 1.000 | −27.554 | −3.500 | −21.926 | −0.741 | 0.000 | −0.672 |
| | surface of | | | | | | | | |
| | second | | | | | | | | |
| | reflecting | | | | | | | | |
| | element 90a | | | | | | | | |
| 14 | Second | — | 1.000 | −14.695 | 0.000 | −112.686 | 0.167 | 0.000 | −0.986 |
| | scanned | | | | | | | | |
| | surface 100b | | | | | | | | |

TABLE 6-1

| | Aspherical coefficient | | | | | | |
|---|---|---|---|---|---|---|---|
| | | Lower portion 21al of | | Upper portion 61a of | | | |
| | | first incident optical | | first imaging optical | | Second imaging optical | |
| | | element 20a | | element 60a | | element 80a | |
| | | Incident | Exit | Incident | Exit | Incident | Exit |
| | Coefficient | surface | surface | surface | surface | surface | surface |
| Meridional | R | — | −3.717E+01 | −7.066E+01 | −4.280E+01 | −4.000E+03 | 3.472E+02 |
| line | K | — | — | 8.400E−01 | −5.308E−01 | — | −8.636E+01 |
| | B3 | — | — | — | — | — | — |
| | B4 | — | — | −8.279E−07 | −3.075E−07 | — | −2.029E−07 |
| | B5 | — | — | — | — | — | — |
| | B6 | — | — | 6.693E−09 | 1.674E−09 | — | 1.634E−11 |
| | B7 | — | — | — | — | — | — |
| | B8 | — | — | −5.668E−12 | 1.147E−12 | — | −9.586E−16 |
| | B9 | — | — | — | — | — | — |
| | B10 | — | — | 1.627E−15 | −1.200E−15 | — | 2.624E−20 |
| Sagittal line | r | — | −2.617E+01 | 2.000E+01 | 1.866E+01 | 3.600E+01 | −1.458E+02 |
| | E1 | — | — | — | — | — | 3.414E−07 |
| | E2 | — | — | — | 2.074E−05 | −8.693E−07 | 1.764E−06 |
| | E3 | — | — | — | — | — | −3.306E−09 |
| | E4 | — | — | — | 7.575E−09 | — | −3.165E−10 |
| | E5 | — | — | — | | — | 1.363E−12 |
| | E6 | — | — | — | −2.732E−11 | — | 3.231E−14 |
| | E7 | — | — | — | | — | −2.056E−16 |
| | E8 | — | — | — | −1.377E−14 | — | −2.120E−18 |
| | E9 | — | — | — | — | — | 1.015E−20 |
| | E10 | — | — | — | 3.289E−17 | — | 6.916E−23 |
| Additional | M0_1 | — | — | — | −3.160E−03 | −1.020E−01 | 2.178E−02 |
| item | M1_1 | — | — | — | — | −1.693E−04 | −1.586E−04 |
| | M2_1 | — | — | — | 5.002E−05 | −1.359E−05 | −2.437E−05 |
| | M3_1 | — | — | — | — | 1.172E−07 | 1.054E−07 |
| | M4_1 | — | — | — | — | 1.554E−09 | 3.596E−09 |
| | M5_1 | — | — | — | — | −1.620E−11 | −1.352E−11 |
| | M6_1 | — | — | — | — | 2.900E−13 | −3.411E−13 |
| | M7_1 | — | — | — | — | 1.196E−15 | 9.645E−16 |
| | M8_1 | — | — | — | — | −1.790E−17 | 6.531E−17 |
| | M9_1 | — | — | — | — | −1.503E−20 | −4.354E−21 |
| | M10_1 | — | — | — | — | −8.145E−22 | −4.321E−21 |
| | C3 | −8.669E−03 | — | — | — | — | — |
| | C5 | −7.847E−03 | — | — | — | — | — |

TABLE 6-2

| | Aspherical coefficient | | | | | | |
|---|---|---|---|---|---|---|---|
| | | Upper portion 21au of | | Lower portion 62a of | | | |
| | | first incident optical | | first imaging optical | | Second imaging optical | |
| | | element 20a | | element 60a | | element 80b | |
| | | Incident | Exit | Incident | Exit | Incident | Exit |
| | Coefficient | surface | surface | surface | surface | surface | surface |
| Meridional | R | — | −3.717E+01 | −7.066E+01 | −4.369E+01 | 4.000E+03 | −3.768E+02 |
| line | K | — | — | 8.400E−01 | −9.590E−01 | — | −7.588E+01 |
| | B3 | — | — | — | — | — | — |
| | B4 | — | — | −8.279E−07 | −1.310E−06 | — | 1.316E−07 |
| | B5 | — | — | — | — | — | — |
| | B6 | — | — | 6.693E−09 | 1.629E−09 | — | −6.963E−12 |
| | B7 | — | — | — | — | — | — |
| | B8 | — | — | −5.668E−12 | 9.682E−13 | — | 2.883E−16 |
| | B9 | — | — | — | — | — | — |
| | B10 | — | — | 1.627E−15 | −1.037E−15 | — | −5.597E−21 |
| Sagittal line | r | — | −2.617E+01 | 2.000E+01 | 3.451E+01 | −4.388E+01 | 1.074E+02 |
| | E1 | — | — | — | — | — | — |
| | E2 | — | — | — | 6.426E−07 | 8.351E−07 | −1.142E−06 |
| | E3 | — | — | — | | — | — |
| | E4 | — | — | — | 1.145E−07 | — | 3.240E−10 |
| | E5 | — | — | — | — | — | — |
| | E6 | — | — | — | −3.029E−10 | — | −4.668E−14 |
| | E7 | — | — | — | | — | — |
| | E8 | — | — | — | 3.690E−13 | — | 3.817E−18 |
| | E9 | — | — | — | | — | — |
| | E10 | — | — | — | −1.754E−16 | — | −1.197E−22 |
| Additional | M0_1 | — | — | — | 6.400E−02 | −1.199E−01 | 5.958E−02 |
| item | M1_1 | — | — | — | — | −3.345E−04 | −3.210E−04 |
| | M2_1 | — | — | — | −5.394E−05 | −1.051E−05 | −2.282E−05 |
| | M3_1 | — | — | — | — | 1.483E−07 | 1.373E−07 |
| | M4_1 | — | — | — | — | 5.340E−10 | 2.784E−09 |
| | M5_1 | — | — | — | — | −2.399E−11 | −2.153E−11 |
| | M6_1 | — | — | — | — | 2.767E−13 | −1.997E−13 |
| | M7_1 | — | — | — | — | 1.964E−15 | 1.737E−15 |
| | M8_1 | — | — | — | — | −9.096E−18 | 3.364E−17 |
| | M9_1 | — | — | — | — | −6.123E−20 | −5.247E−20 |
| | M10_1 | — | — | — | — | −1.768E−22 | −1.366E−21 |
| | C3 | −8.669E−03 | — | — | — | — | — |
| | C5 | −7.847E−03 | — | — | — | — | — |

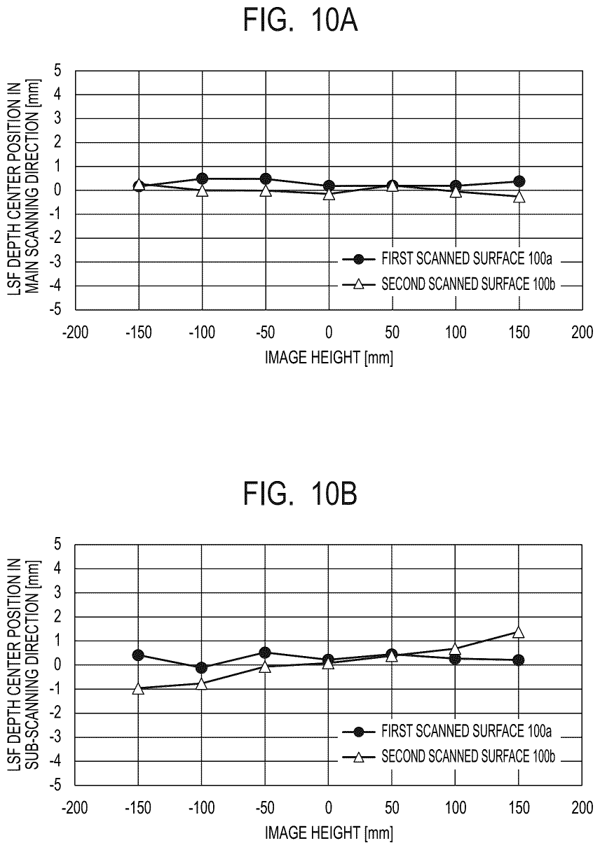

FIG. 10A and FIG. 10B show image height dependence of the LSF depth center position in the main scanning direction and of the LSF depth center position in the sub-scanning direction, respectively, on each scanned surface in the light scanning apparatus 201 according to the present embodiment.

As shown in FIG. 10A, the LSF depth center position in the main scanning direction falls within +1 mm for entire image heights.

As shown in FIG. 10B, the LSF depth center position in the sub-scanning direction falls within +1 mm for all but some image heights.

The above shows that excellent imaging performance is achieved in the light scanning apparatus 201 according to the present embodiment.

As described above, in the light scanning apparatus 201 according to the present embodiment, the first incident optical element 20a and the second reflecting element 90a are held by the projecting portion 2p integrally formed with the housing 2.

Both of the first incident optical element 20a and the second reflecting element 90a can thus be held with a simple configuration when downsizing is to be achieved by placing the first incident optical element 20a and the second reflecting element 90a close to each other.

### Third Embodiment

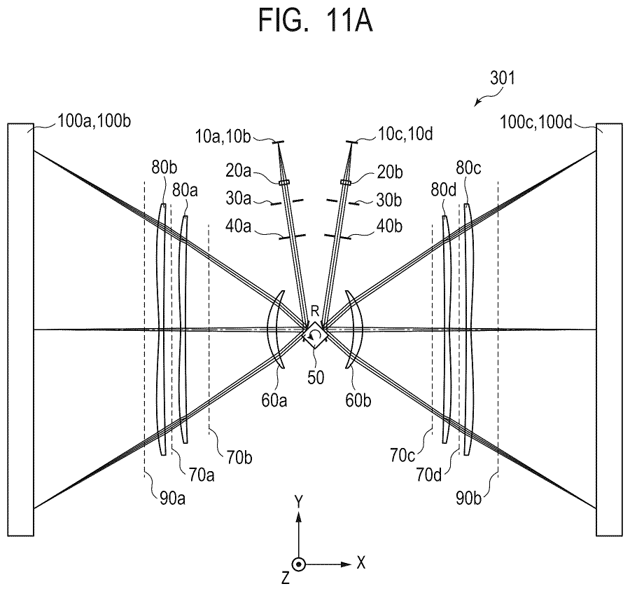

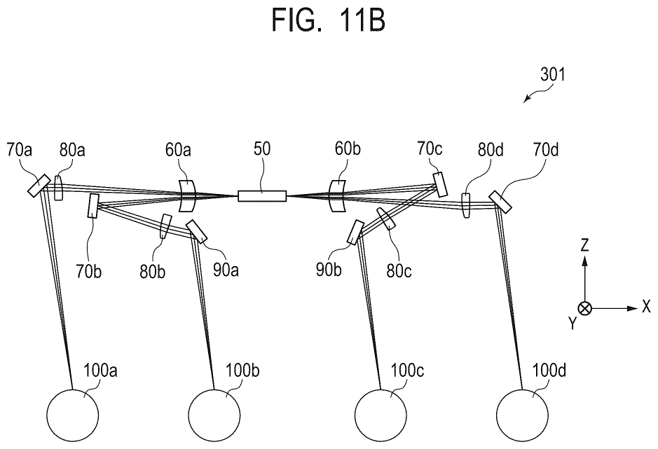

FIG. 11A and FIG. 11B show a developed view (corresponding to FIG. 1A) in a main scanning cross section of a light scanning apparatus 301 according to a third embodiment of the present invention, and a partial sub-scanning cross sectional view (corresponding to FIG. 1B) thereof, respectively.

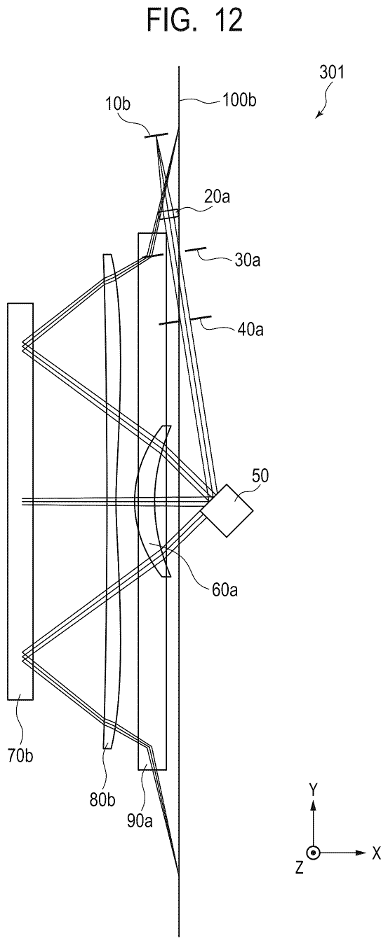

FIG. 12 shows a partial projected view (corresponding to FIG. 3) in the main scanning cross section of the light scanning apparatus 301 according to the third embodiment.

The light scanning apparatus 301 according to the present embodiment has the same configuration as that of the light scanning apparatus 1 according to the first embodiment, except for differences in various numerical values. Accordingly, the same members are denoted by the same reference numbers, and descriptions thereof are omitted.

Specification values of the light scanning apparatus 301 according to the present embodiment, refractive indices and coordinates of the respective optical elements, and shapes of optical surfaces of the respective optical elements are shown in Table 7, Table 8, and Table 9-1 and Table 9-2, respectively.

In Table 8, Table 9-1, and Table 9-2, information about only the first and second incident optical systems and the first and second imaging optical systems is shown.

That is, in Table 8, Table 9-1, and Table 9-2, information about the third and fourth incident optical systems and the third and fourth imaging optical systems is omitted.

TABLE 7

| | Parameter · | |
|---|---|---|
| Item | Unit | Value |
| Wavelength used by first to fourth | λ [nm] | 790 |
| light sources 10a to 10d | | |
| Scanning width of first to fourth | h [mm] | 326 |
| scanned surfaces 100a to 100d | | |
| Number of deflecting surfaces of | [Surface] | 4 |
| deflecting unit 50 | | |
| Circumscribed circle diameter of | Pd [mm] | 20 |
| deflecting unit 50 | | |
| Maximum scanning angle of | θmax [rad] | 0.787 |
| deflecting unit 50 | | |
| Rotation center coordinates of | (X, Y) [mm] | (5.87, −4.02) |
| deflecting unit 50 | | |
| Absolute value of incident angle of first | θim [deg] | 81.00 |
| to fourth incident optical systems in | | |
| main scanning cross section | | |
| Absolute value of incident angle of first | θis [deg] | 2.70 |
| to fourth incident optical systems in | | |
| sub-scanning cross section | | |
| Width of respective aperture portions | As [mm] | 2.84 |
| of first and second sub-scanning stops | | |
| 30a and 30b in sub-scanning direction | | |
| Width of respective aperture portions of | Am [mm] | 3.75 |
| first and second main scanning stops | | |
| 40a and 40b in main scanning direction | | |
| Distance in X-direction between | Lx [mm] | 19.71 |
| on-axis deflection point C0 and centers | | |
| of exit surfaces of first and | | |
| second incident optical elements 20a and 20b | | |
| Distance in Y-direction between | Ly [mm] | 124.42 |
| on-axis deflection point C0 and centers | | |
| of exit surfaces of first and | | |
| second incident optical elements 20a and 20b | | |
| Distance in XY cross section | Lt [mm] | 126.11 |
| between on-axis deflection point C0 | | |
| and centers of exit surfaces of | | |
| first and second incident optical | | |
| elements 20a and 20b | | |
| Distance in optical axis | Li [mm] | 161.70 |
| direction of first to fourth incident optical | | |
| systems between first to fourth | | |
| light sources 10a to 10d and | | |
| on-axis deflection point C0 | | |
| Distance in X-direction between | Mx [mm] | 27.55 |
| on-axis deflection point C0 and centers | | |
| of reflecting surfaces of | | |
| second reflecting elements 90a and 90b | | |
| Distance in Y-direction between | My [mm] | 116.50 |
| on-axis deflection point C0 and centers | | |
| of reflecting surfaces of | | |
| second reflecting elements 90a and 90b | | |

TABLE 8

| | | | Refractive | | | | | | |
|---|---|---|---|---|---|---|---|---|---|
| | | Surface | index | | | | | | |
| Surface | | interval | (λ = 790 | Coordinates of surface vertex | | | Direction cosine of optical axis | | |
| number | | [mm] | nm) | tc(x) | tc(y) | tc(z) | gx(x) | gx(y) | gx(z) |
| 1 | First light | 0.250 | 1.000 | −25.267 | 159.532 | −7.617 | −0.156 | 0.987 | −0.047 |
| | source 10a | | | | | | | | |
| 2 | Glass cover | 33.340 | 1.511 | −25.228 | 159.285 | −7.605 | −0.156 | 0.987 | −0.047 |
| | for laser chip | | | | | | | | |
| 3 | Incident | 3.000 | 1.528 | −20.019 | 126.392 | −6.035 | −0.156 | 0.987 | −0.047 |
| | surface of | | | | | | | | |
| | lower portion | | | | | | | | |
| | 21al of first | | | | | | | | |
| | incident | | | | | | | | |
| | optical | | | | | | | | |
| | element 20a | | | | | | | | |
| 4 | Exit surface | 15.150 | 1.000 | −19.550 | 123.433 | −5.893 | −0.156 | 0.987 | −0.047 |
| | of lower | | | | | | | | |
| | portion 21al | | | | | | | | |
| | of first | | | | | | | | |
| | incident | | | | | | | | |
| | optical | | | | | | | | |
| | element 20a | | | | | | | | |
| 5 | Lower | 29.870 | 1.000 | −17.182 | 108.486 | −5.180 | −0.156 | 0.988 | 0.000 |
| | aperture | | | | | | | | |
| | portion 30al | | | | | | | | |
| | of first sub- | | | | | | | | |
| | scanning stop | | | | | | | | |
| | 30a | | | | | | | | |
| 6 | Aperture | 80.090 | 1.000 | −12.515 | 79.016 | −3.773 | 0.156 | 0.988 | 0.000 |
| | portion of first | | | | | | | | |
| | main scanning | | | | | | | | |
| | stop 40a | | | | | | | | |
| 7 | First | 26.000 | 1.000 | 0.492 | 0.576 | 0.000 | −0.760 | 0.649 | 0.000 |
| | deflecting | | | | | | | | |
| | surface 50a of | | | | | | | | |
| | deflecting unit | | | | | | | | |
| | 50 (in on-axis | | | | | | | | |
| | image height | | | | | | | | |
| | scanning) | | | | | | | | |
| 8 | Incident | 8.200 | 1.528 | −26.000 | 0.000 | 0.000 | −1.000 | 0.000 | 0.000 |
| | surface of | | | | | | | | |
| | upper portion | | | | | | | | |
| | 61a of first | | | | | | | | |
| | imaging | | | | | | | | |
| | optical | | | | | | | | |
| | element 60a | | | | | | | | |
| 9 | Exit surface | 69.300 | 1.000 | −34.200 | 0.000 | 0.000 | −1.000 | 0.000 | 0.000 |
| | of upper | | | | | | | | |
| | portion 61a of | | | | | | | | |
| | first imaging | | | | | | | | |
| | optical | | | | | | | | |
| | element 60a | | | | | | | | |
| 11 | Incident | 4.300 | 1.528 | −103.500 | 0.000 | 5.030 | −1.000 | 0.000 | 0.000 |
| | surface of | | | | | | | | |
| | second | | | | | | | | |
| | imaging | | | | | | | | |
| | optical | | | | | | | | |
| | element 80a | | | | | | | | |
| 12 | Exit surface | 10.670 | 1.000 | −107.800 | 0.000 | 5.030 | −1.000 | 0.000 | 0.000 |
| | of second | | | | | | | | |
| | imaging | | | | | | | | |
| | optical | | | | | | | | |
| | element 80a | | | | | | | | |
| 13 | Reflecting | 114.530 | 1.000 | −114.192 | 5.000 | 4.980 | −0.759 | 0.000 | 0.652 |
| | surface of first | | | | | | | | |
| | reflecting | | | | | | | | |
| | element 70a | | | | | | | | |
| 14 | First scanned | — | 1.000 | −97.695 | 0.000 | −112.686 | −0.151 | 0.000 | 0.989 |
| | surface 100a | | | | | | | | |
| 1 | Second light | 0.250 | 1.000 | −25.267 | 159.532 | 7.617 | −0.156 | 0.987 | 0.047 |
| | source 10b | | | | | | | | |
| 2 | Glass cover | 33.340 | 1.511 | −25.228 | 159.285 | 7.605 | −0.156 | 0.987 | 0.047 |
| | for laser chip | | | | | | | | |
| 3 | Incident | 3.000 | 1.528 | −20.019 | 126.392 | 6.035 | −0.156 | 0.987 | 0.047 |
| | surface of | | | | | | | | |
| | upper portion | | | | | | | | |
| | 21au of first | | | | | | | | |
| | incident | | | | | | | | |
| | optical | | | | | | | | |
| | element 20a | | | | | | | | |
| 4 | Exit surface | 15.150 | 1.000 | −19.550 | 123.433 | 5.893 | −0.156 | 0.987 | 0.047 |
| | of upper | | | | | | | | |
| | portion 21au | | | | | | | | |
| | of first | | | | | | | | |
| | incident | | | | | | | | |
| | optical | | | | | | | | |
| | element 20a | | | | | | | | |
| 5 | Upper | 29.870 | 1.000 | −17.182 | 108.486 | 5.180 | −0.156 | 0.988 | 0.000 |
| | aperture | | | | | | | | |
| | portion 30au | | | | | | | | |
| | of first sub- | | | | | | | | |
| | scanning stop | | | | | | | | |
| | 30a | | | | | | | | |
| 6 | Aperture | 80.090 | 1.000 | −12.515 | 79.016 | 3.773 | −0.156 | 0.988 | 0.000 |
| | portion of first | | | | | | | | |
| | main scanning | | | | | | | | |
| | stop 40a | | | | | | | | |
| 7 | First | 26.000 | 1.000 | 0.492 | 0.576 | 0.000 | −0.760 | 0.649 | 0.000 |
| | deflecting | | | | | | | | |
| | surface 50a of | | | | | | | | |
| | deflecting unit | | | | | | | | |
| | 50 (in on-axis | | | | | | | | |
| | image height | | | | | | | | |
| | scanning) | | | | | | | | |
| 8 | Incident | 8.200 | 1.528 | −26.000 | 0.000 | 0.000 | −1.000 | 0.000 | 0.000 |
| | surface of | | | | | | | | |
| | lower portion | | | | | | | | |
| | 62a of first | | | | | | | | |
| | imaging | | | | | | | | |
| | optical | | | | | | | | |
| | element 60a | | | | | | | | |
| 9 | Exit surface | 48.348 | 1.000 | −34.200 | 0.000 | 0.000 | −1.000 | 0.000 | 0.000 |
| | of lower | | | | | | | | |
| | portion 62a of | | | | | | | | |
| | first imaging | | | | | | | | |
| | optical | | | | | | | | |
| | element 60a | | | | | | | | |
| 10 | Reflecting | 39.452 | 1.000 | −83.252 | 0.000 | −5.275 | −0.991 | 0.000 | 0.132 |
| | surface of first | | | | | | | | |
| | reflecting | | | | | | | | |
| | element 70b | | | | | | | | |
| 11 | Incident | 4.300 | 1.528 | −46.366 | 0.000 | −17.300 | −0.965 | 0.000 | 0.262 |
| | surface of | | | | | | | | |
| | second | | | | | | | | |
| | imaging | | | | | | | | |
| | optical | | | | | | | | |
| | element 80b | | | | | | | | |
| 12 | Exit surface | 4.523 | 1.000 | −42.216 | 0.000 | −18.427 | −0.965 | 0.000 | 0.262 |
| | of second | | | | | | | | |
| | imaging | | | | | | | | |
| | optical | | | | | | | | |
| | element 80b | | | | | | | | |
| 13 | Reflecting | 102.177 | 1.000 | −27.554 | −3.500 | −21.926 | −0.741 | 0.000 | −0.672 |
| | surface of | | | | | | | | |
| | second | | | | | | | | |
| | reflecting | | | | | | | | |
| | element 90a | | | | | | | | |
| 14 | Second | — | 1.000 | −14.695 | 0.000 | −112.686 | 0.167 | 0.000 | −0.986 |
| | scanned | | | | | | | | |
| | surface 100b | | | | | | | | |

TABLE 9-1

| | Aspherical coefficient | | | | | | |
|---|---|---|---|---|---|---|---|
| | | Lower portion 21al of | | Upper portion 61a of | | | |
| | | first incident optical | | first imaging optical | | Second imaging optical | |
| | | element 20a | | element 60a | | element 80a | |
| | | Incident | Exit | Incident | Exit | Incident | Exit |
| | Coefficient | surface | surface | surface | surface | surface | surface |
| Meridional | R | — | −3.721E+01 | −7.114E+01 | −4.293E+01 | −4.000E+03 | 3.487E+02 |
| line | K | — | — | 9.125E−01 | −5.179E−01 | — | −8.539E+01 |
| | B3 | — | — | — | — | — | — |
| | B4 | — | — | −8.821E−07 | −3.506E−07 | — | −2.027E−07 |
| | B5 | — | — | — | — | — | — |
| | B6 | — | — | 6.733E−09 | 1.793E−09 | — | 1.624E−11 |
| | B7 | — | — | — | — | — | — |
| | B8 | — | — | −5.950E−12 | 9.087E−13 | — | −9.361E−16 |
| | B9 | — | — | — | — | — | — |
| | B10 | — | — | 1.780E−15 | −1.182E−15 | — | 2.520E−20 |
| Sagittal line | r | — | −2.596E+01 | 2.000E+01 | 1.320E+01 | 3.640E+01 | −1.219E+02 |
| | E1 | — | — | — | — | — | 6.689E−07 |
| | E2 | — | — | — | 1.551E−05 | −6.129E−07 | 2.191E−06 |
| | E3 | — | — | — | — | — | −2.483E−09 |
| | E4 | — | — | — | −1.778E−08 | — | −3.367E−10 |
| | E5 | — | — | — | — | — | 8.338E−13 |
| | E6 | — | — | — | −1.946E−11 | — | 2.919E−14 |
| | E7 | — | — | — | — | — | −9.455E−17 |
| | E8 | — | — | — | −6.742E−15 | — | −6.591E−19 |
| | E9 | — | — | — | — | — | 2.801E−21 |
| | E10 | — | — | — | 3.937E−17 | — | −4.915E−23 |
| Additional | M0_1 | — | — | — | 2.383E−02 | −9.872E−02 | 2.561E−02 |
| item | M1_1 | — | — | — | — | −2.395E−04 | −2.289E−04 |
| | M2_1 | — | — | — | 4.122E−05 | −1.166E−05 | −2.240E−05 |
| | M3_1 | — | — | — | — | 1.159E−07 | 1.063E−07 |
| | M4_1 | — | — | — | — | 2.040E−09 | 3.845E−09 |
| | M5_1 | — | — | — | — | −1.565E−11 | −1.422E−11 |
| | M6_1 | — | — | — | — | 3.045E−13 | −2.846E−13 |
| | M7_1 | — | — | — | — | 1.049E−15 | 1.065E−15 |
| | M8_1 | — | — | — | — | −1.155E−17 | 6.558E−17 |
| | M9_1 | — | — | — | — | −2.407E−20 | −2.974E−20 |
| | M10_1 | — | — | — | — | −8.105E−22 | −3.747E−21 |
| | C3 | −8.669E−03 | — | — | — | — | — |
| | C5 | −7.847E−03 | — | — | — | — | — |

TABLE 9-2

| | Aspherical coefficient | | | | | | |
|---|---|---|---|---|---|---|---|
| | | Upper portion 21au of | | Lower portion 62a of | | | |
| | | first incident optical | | first imaging optical | | Second imaging optical | |
| | | element 20a | | element 60a | | element 80b | |
| | | Incident | Exit | Incident | Exit | Incident | Exit |
| | Coefficient | surface | surface | surface | surface | surface | surface |
| Meridional | R | — | −3.721E+01 | −7.114E+01 | −4.384E+01 | 4.000E+03 | −3.787E+02 |
| line | K | — | — | 9.125E−01 | −9.255E−01 | — | −7.507E+01 |
| | B3 | — | — | — | — | — | — |
| | B4 | — | — | −8.821E−07 | −1.361E−06 | — | 1.315E−07 |
| | B5 | — | — | — | — | — | — |
| | B6 | — | — | 6.733E−09 | 1.798E−09 | — | −6.888E−12 |
| | B7 | — | — | — | — | — | — |
| | B8 | — | — | −5.950E−12 | 7.873E−13 | — | 2.707E−16 |
| | B9 | — | — | — | — | — | — |
| | B10 | — | — | 1.780E−15 | −1.100E−15 | — | −4.794E−21 |
| Sagittal line | r | — | −2.596E+01 | 2.000E+01 | 1.337E+01 | −4.061E+01 | 1.029E+02 |
| | E1 | — | — | — | — | — | — |
| | E2 | — | — | — | −3.012E−05 | 3.266E−07 | −1.807E−06 |
| | E3 | — | — | — | — | — | — |
| | E4 | — | — | — | 1.604E−07 | — | 3.110E−10 |
| | E5 | — | — | — | — | — | — |
| | E6 | — | — | — | −4.008E−10 | — | −4.083E−14 |
| | E7 | — | — | — | — | — | — |
| | E8 | — | — | — | 3.956E−13 | — | 3.025E−18 |
| | E9 | — | — | — | — | — | — |
| | E10 | — | — | — | −1.318E−16 | — | −8.886E−23 |
| Additional | M0_1 | — | — | — | 7.657E−03 | −1.127E−01 | 6.735E−02 |
| item | M1_1 | — | — | — | — | −3.558E−04 | −3.438E−04 |
| | M2_1 | — | — | — | −3.968E−05 | −8.073E−06 | −2.053E−05 |
| | M3_1 | — | — | — | — | 1.504E−07 | 1.392E−07 |
| | M4_1 | — | — | — | — | 8.447E−10 | 2.994E−09 |
| | M5_1 | — | — | — | — | −2.388E−11 | −2.139E−11 |
| | M6_1 | — | — | — | — | 2.688E−13 | −1.934E−13 |
| | M7_1 | — | — | — | — | 1.942E−15 | 1.707E−15 |
| | M8_1 | — | — | — | — | −9.832E−18 | 3.319E−17 |
| | M9_1 | — | — | — | — | −6.019E−20 | −5.082E−20 |
| | M10_1 | — | — | — | — | 1.051E−22 | −1.313E−21 |
| | C3 | −8.669E−03 | — | — | — | — | — |
| | C5 | −7.847E−03 | — | — | — | — | — |

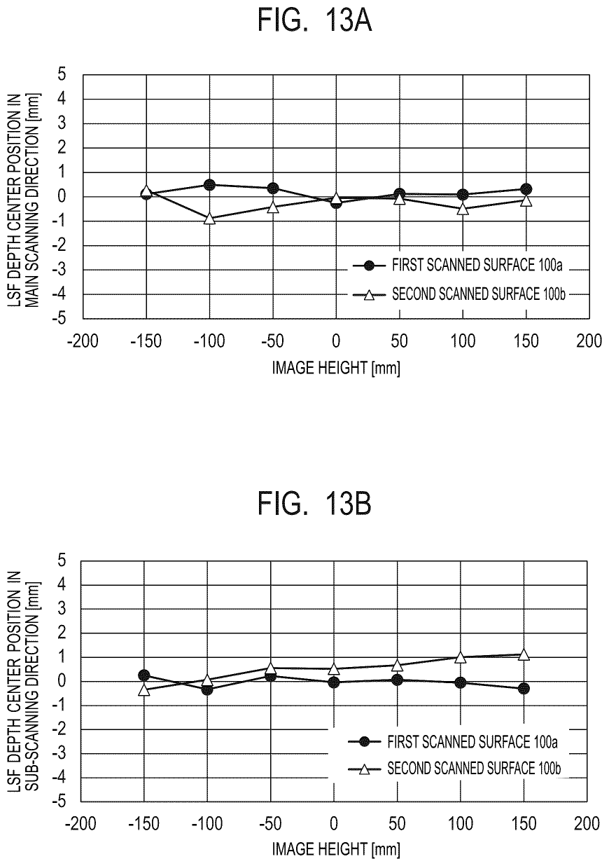

FIG. 13A and FIG. 13B show image height dependence of the LSF depth center position in the main scanning direction and of the LSF depth center position in the sub-scanning direction, respectively, on each scanned surface in the light scanning apparatus 301 according to the present embodiment.

As shown in FIG. 13A, the LSF depth center position in the main scanning direction falls within +1 mm for entire image heights.

As shown in FIG. 13B, the LSF depth center position in the sub-scanning direction falls within +1 mm for all but some image heights.

The above shows that excellent imaging performance is achieved in the light scanning apparatus 301 according to the present embodiment.

As described above, in the light scanning apparatus 301 according to the present embodiment, the first incident optical element 20a and the second reflecting element 90a are held by the projecting portion 2p integrally formed with the housing 2.

Both of the first incident optical element 20a and the second reflecting element 90a can thus be held with a simple configuration when downsizing is to be achieved by placing the first incident optical element 20a and the second reflecting element 90a close to each other.

Relationships between the various numerical values and Inequalities in respective light scanning apparatuses according to the first to third embodiments of the present invention are shown in Table 10 below.

TABLE 10

| | | First | Second | Third |
|---|---|---|---|---|
| | | Embodi- | Embodi- | Embodi- |
| | Inequality | ment | ment | ment |
| (5) | 0.500 < M_{X}/L_{X} < 1.500 | 1.060 | 0.800 | 1.398 |
| (5a) | 0.700 < M_{X}/L_{X} < 1.400 | | | |
| (6) | 0.9000 < M_{Y}/L_{Y} < 0.9700 | 0.9530 | 0.9698 | 0.9363 |
| (6a) | 0.9300 < M_{Y}/L_{Y} < 0.9700 | | | |
| (7) | 0.70 < Lₜ/Lⱼ < 0.90 | 0.77 | 0.77 | 0.78 |
| (7a) | 0.75 < Lₜ/Lⱼ < 0.85 | | | |

According to the present embodiments, a light scanning apparatus that has achieved downsizing with a simple configuration can be provided.

[Image Forming Apparatus]

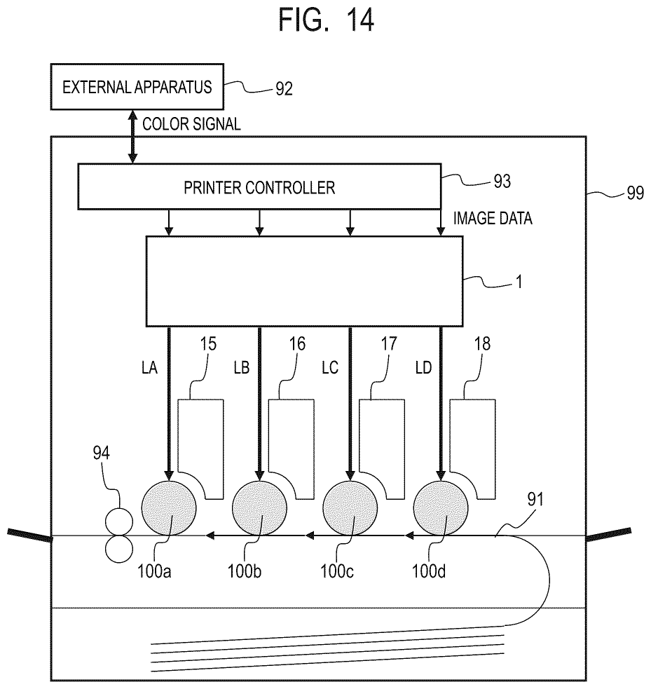

FIG. 14 shows a sub-scanning cross sectional view of a main part of an image forming apparatus 99 including the light scanning apparatus 1 according to any one of the first to third embodiments.

The image forming apparatus 99 is a tandem-type color image forming apparatus in which the light scanning apparatus 1 according to any one of the first to third embodiments records image information on surfaces (scanned surfaces) of four photosensitive drums each of which is an image bearing member.

The image forming apparatus 99 includes the light scanning apparatus 1 according to any one of the first to third embodiments and first, second, third, and fourth photosensitive drums 100a, 100b, 100c, and 100d serving as image bearing members.

The image forming apparatus 99 also includes first, second, third, and fourth developing units 15, 16, 17, and 18, a conveying belt 91, a printer controller 93, and a fixing unit 94.

As illustrated in FIG. 14, color signals of red (R), green (G), and blue (B) output from an external apparatus 92, for example, a personal computer is input to the image forming apparatus 99.

Those input color signals are then converted into pieces of image data (dot data) on cyan (C), magenta (M), yellow (Y), and black (K) by the printer controller 93 in the image forming apparatus 99.

Next, the pieces of image data generated by the conversion are input to the light scanning apparatus 1 according to any one of the first to third embodiments.

The first, second, third, and fourth light fluxes LA, LB, LC, and LD modulated based on the pieces of image data are emitted from the light scanning apparatus 1, and photosensitive surfaces of the first to fourth photosensitive drums 100a to 100d are scanned with the first, second, third, and fourth light fluxes LA, LB, LC, and LD in the main scanning direction.

Charging rollers (not shown) which uniformly charge the photosensitive surfaces of the first to fourth photosensitive drums 100a to 100d are provided so as to be brought into abutment against the photosensitive surfaces.

The light scanning apparatus 1 then irradiates, with the first to fourth light fluxes LA to LD, the photosensitive surfaces of the first to fourth photosensitive drums 100a to 100d charged by the charging rollers.

As described above, the first to fourth light fluxes LA to LD have been modulated based on the pieces of image data of the respective colors, and electrostatic latent images are formed on the respective photosensitive surfaces of the first to fourth photosensitive drums 100a to 100d, by irradiating the photosensitive surfaces with the first to fourth light fluxes LA to LD.

The formed electrostatic latent images are developed as toner images by the first to fourth developing units 15 to 18 arranged so as to abut against the first to fourth photosensitive drums 100a to 100d, respectively.

Next, the developed toner images are transferred onto a sheet (a transferred material) (not shown) being conveyed on the conveying belt 91 in a superimposed manner by transferring rollers (transferring unit) (not shown) arranged so as to be opposed to the first to fourth photosensitive drums 100a to 100d. One full-color image is thus formed on the sheet.

The sheet onto which the unfixed toner images have been transferred is further conveyed by the conveying belt 91 to the fixing unit 94 provided downstream (on the left side of FIG. 14) of the first to fourth photosensitive drums 100a to 100d.

The fixing unit 94 includes a fixing roller containing a fixing heater (not shown) therein, and a pressurizing roller arranged so as to be brought into pressure contact with the fixing roller.

The unfixed toner images on the sheet are fixed by heating, under pressure applied from a pressure contact portion between the fixing roller and the pressurizing roller, the sheet having been conveyed by the conveying belt 91.

Discharging rollers (not shown) are further provided downstream of the fixing unit 94, and discharge the sheet onto which the toner images have been fixed to the outside of the image forming apparatus 99.

In the image forming apparatus 99, the light scanning apparatus 1 records image signals (image information) on the photosensitive surfaces of the first to fourth photosensitive drums 100a to 100d each corresponding to one of colors of cyan (C), magenta (M), Y (yellow), and K (black). A color image can thus be printed at high speed.

As the external apparatus 92, for example, a color image reading apparatus including a CCD sensor may be used.

In this case, this color image reading apparatus and the image forming apparatus 99 form a color digital copying machine.

While the embodiments of the present invention have been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-166649, filed Sep. 28, 2023, which is hereby incorporated by reference herein in its entirety.

What is claimed is:

1. A light scanning apparatus comprising:
a deflecting unit configured to deflect a first light flux from a first light source to scan a first scanned surface in a main scanning direction;
a first imaging optical system and a reflecting element which are configured to guide the first light flux deflected by the deflecting unit to the first scanned surface;
an optical element configured to guide the first light flux emitted from the first light source to the deflecting unit; and
a holding member configured to hold the deflecting unit, the first imaging optical system, the reflecting element, and the optical element,
wherein the optical element and the reflecting element abut against the holding member.

2. The light scanning apparatus according to claim 1, wherein the optical element is arranged on a line extending in the main scanning direction from the reflecting element when they are projected in a main scanning cross section.

3. The light scanning apparatus according to claim 1, wherein the holding member includes a first holding portion extending in a sub-scanning direction, and the optical element and the reflecting element abut against the first holding portion.

4. The light scanning apparatus according to claim 3, wherein the first holding portion is provided with a first aperture portion configured to regulate the first light flux in the sub-scanning direction.

5. The light scanning apparatus according to claim 3, wherein the first holding portion includes a plurality of protruding portions which abut against a surface on a deflecting unit side of the optical element.

6. The light scanning apparatus according to claim 5, wherein the holding member includes a biasing portion configured to bias the optical element toward the plurality of protruding portions.

7. The light scanning apparatus according to claim 5, wherein the plurality of protruding portions differ from one another in length in the main scanning cross section.

8. The light scanning apparatus according to claim 5, wherein the surface on the deflecting unit side of the optical element includes a plurality of protruding portions which abut against the plurality of protruding portions.

9. The light scanning apparatus according to claim 1, wherein the optical element is configured to convert a degree of convergence of the first light flux in a main scanning cross section, and to condense the first light flux in a sub-scanning cross section.

10. The light scanning apparatus according to claim 1, further comprising a second imaging optical system configured to guide a second light flux deflected by the deflecting unit to a second scanned surface,
wherein the deflecting unit is configured to deflect the first light flux and the second light flux by a first deflecting surface to scan the first scanned surface and the second scanned surface in the main scanning direction, respectively, and
wherein the optical element includes a first optical portion configured to guide the first light flux to the first deflecting surface, and a second optical portion configured to guide the second light flux to the first deflecting surface.

11. The light scanning apparatus according to claim 10, wherein the holding member includes a first holding portion extending in a sub-scanning direction, the optical element and the reflecting element abut against the first holding portion, and the first holding portion is provided with a first aperture portion and a second aperture portion which are configured to regulate the first light flux and the second light flux in the sub-scanning direction.

12. The light scanning apparatus according to claim 3, wherein the optical element abuts against the first holding portion in the main scanning direction, and the reflecting element abuts against the first holding portion in the sub-scanning direction.

13. The light scanning apparatus according to claim 3,
wherein the holding member includes a housing in which the deflecting unit, the first imaging optical system, the reflecting element, and the optical element are arranged, and
wherein the first holding portion projects from a bottom surface of the housing in the sub-scanning direction.

14. The light scanning apparatus according to claim 1, further comprising a second imaging optical system configured to guide a second light flux deflected by the deflecting unit to a second scanned surface,
wherein the deflecting unit is configured to deflect the first light flux and the second light flux by a first deflecting surface to scan the first scanned surface and the second scanned surface in the main scanning direction, respectively, and
wherein the following condition is satisfied:
$$0.5 < {M}_{X} / {L}_{X} < 1.5 ,$$
where Lx represents a distance in a first direction between an on-axis deflection point of the first light flux on the first deflecting surface and a center of a surface of the optical element which abuts against the holding member, the first direction being parallel to a straight line running through a first intersection of the first scanned surface and an optical axis of the first imaging optical system, and a second intersection of the second scanned surface and an optical axis of the second imaging optical system, and M_{X} represents a distance in the first direction between the on-axis deflection point and a center of a reflecting surface of the reflecting element.

15. The light scanning apparatus according to claim 1, wherein the following condition is satisfied:
$$0.9 < {M}_{Y} / {L}_{Y} < 0.97 ,$$
where L_{Y} represents a distance in the main scanning direction between an on-axis deflection point of the first light flux in the deflecting unit and a center of a surface of the optical element which abuts against the holding member, and M_{Y} represents a distance in the main scanning direction between the on-axis deflection point and an end portion of the reflecting element which is closest to the optical element.

16. The light scanning apparatus according to claim 1, wherein the following condition is satisfied:
$$0.7 < {L}_{t} / {L}_{i} < 0.9 ,$$
where Lₜ represents a distance in a main scanning cross section between an on-axis deflection point of the first light flux in the deflecting unit and a center of a surface of the optical element which abuts against the holding member, and Li represents a distance in a direction parallel to an optical axis of the optical element between the first light source and the on-axis deflection point.

17. The light scanning apparatus according to claim 1, wherein the optical element has an incident surface which is a diffractive surface.

18. The light scanning apparatus according to claim 1, further comprising a second imaging optical system, a third imaging optical system, and a fourth imaging optical system which are configured to guide a second light flux, a third light flux, and a fourth light flux which are deflected by the deflecting unit to a second scanned surface, a third scanned surface, and a fourth scanned surface, respectively,
wherein the deflecting unit is configured to deflect the second light flux, the third light flux, and the fourth light flux to scan the second scanned surface, the third scanned surface, and the fourth scanned surface in the main scanning direction, respectively,
wherein the first light flux and the second light flux are incident on a first deflecting surface of the deflecting unit at angles different from each other with respect to a main scanning cross section in a sub-scanning cross section, and
wherein the third light flux and the fourth light flux are incident on a second deflecting surface of the deflecting unit at angles different from each other with respect to the main scanning cross section in the sub-scanning cross section.

19. An image forming apparatus comprising:
the light scanning apparatus according to claim 1;
a developing unit configured to develop, as a toner image, an electrostatic latent image formed by the light scanning apparatus on the first scanned surface;
a transferring unit configured to transfer the developed toner image onto a transferred material; and
a fixing unit configured to fix the transferred toner image to the transferred material.

20. An image forming apparatus comprising:
the light scanning apparatus according to claim 1; and
a printer controller configured to convert a signal output from an external apparatus into image data to input the image data to the light scanning apparatus.
